(19) United States
(12) Patent Application Publication
(10) Pub. No.: US 2025/0034935 A1
(43) Pub. Date: Jan. 30, 2025

(54) INSULATING GLAZING UNIT, SPACER, HOLDER, AND GLAZING ASSEMBLY TECHNOLOGY

(71) Applicant: CARDINAL CG COMPANY, Eden Prairie, MN (US)

(72) Inventors: Megan E. Rose, Verona, WI (US); Kari B. Myli, Sauk City, WI (US); Kellen C. Kitzman, Verona, WI (US); Johnathan E. Weicherding, Minneapolis, MN (US); John Brian Shero, Savage, MN (US)

(21) Appl. No.: 18/781,569

(22) Filed: Jul. 23, 2024

Related U.S. Application Data
(60) Provisional application No. 63/515,250, filed on Jul. 24, 2023.

(51) Int. Cl. E06B 3/673; E06B 3/66; E06B 3/663

(52) U.S. Cl. CPC E06B 3/67326; E06B 3/6612; E06B 3/66304; E06B 3/66342

(57) ABSTRACT

In some embodiments, the invention provides a multiple-pane insulating glazing unit having a between-pane space. An aerogel sheet is located in the between-pane space. Other embodiments provide methods of manufacturing such an IG unit. Further, some embodiments of the invention provide a glazing assembly that includes such an IG unit. Certain embodiments of the invention provide a spacer having a seating structure for supporting an aerogel sheet, while other embodiments provide an aerogel sheet holder for supporting an aerogel sheet. Preliminary glazing assemblies are also provided.

### RELATED APPLICATIONS

This application claims priority to U.S. Provisional Patent Application No. 63/515,250, filed Jul. 24, 2023, the contents of which are incorporated herein by reference.

### FIELD OF THE INVENTION

The present invention relates generally to multiple-pane insulating glazing units, and methods of manufacturing them. More specifically, the invention relates to multiple-pane insulating glazing unit constructions, spacers for such units, and glazing assemblies that include such units, as well as manufacturing methods, components, and preliminary glazing assemblies for IG units.

### BACKGROUND OF THE INVENTION

Various types of glazing assemblies are known. Some include a frame that receives a multiple-pane insulating glazing unit (or “IG unit”). In some cases, the IG unit is held in a vertical orientation by the frame. In other cases, the IG unit is held in a horizontal orientation by the frame. This is often the case with the IG units of roof windows (e.g., “skylights”). In still other cases, the IG unit is held in an inclined orientation by the frame.

Furthermore, various types of IG units are known. Some have two panes, others have three panes.

Aerogel is a known insulation material. In some cases, aerogel has been provided in granular, particulate form. In other cases, aerogel has been provided in sheet form.

It would be desirable to provide IG unit constructions that advantageously incorporate aerogel sheet therein. As one example, it would be advantageous to provide aerogel holders configured to hold aerogel sheets in IG units. As another example, it would be advantageous to provide spacers configured to support and/or carry aerogel sheets in IG units. It would also be desirable to provide glazing assemblies that incorporate such IG units. It would be particularly desirable to provide such glazing assemblies, IG units, aerogel holders, and spacers with a seating structure that facilitates reliable aerogel sheet seating and retention. In addition, it would be desirable to provide methods of manufacturing advantageous IG unit constructions that incorporate aerogel sheet. Similarly, it would be desirable to provide preliminary glazing assemblies that can be used in such methods to produce IG units with aerogel sheet therein.

### BRIEF DESCRIPTION OF THE DRAWINGS

FIG. 1 is a schematic, partially broken-away, cross-sectional side view of a double-pane insulating glazing unit in accordance with certain embodiments of the present invention;

FIG. 2 is a schematic, cross-sectional side view of a double-pane insulating glazing unit in accordance with another embodiment of the invention;

FIG. 3 is a schematic, cross-sectional side view of a double-pane insulating glazing unit in accordance with still another embodiment of the invention;

FIG. 4 is a schematic, cross-sectional side view of a double-pane insulating glazing unit in accordance with yet another embodiment of the invention;

FIG. 5 is a schematic, cross-sectional side view of a triple-pane insulating glazing unit in accordance with certain embodiments of the invention;

FIG. 6 is a schematic, cross-sectional side view of a triple-pane insulating glazing unit in accordance with other embodiments of the invention;

FIG. 7 is a schematic, cross-sectional side view of a triple-pane insulating glazing unit in accordance with still other embodiments of the invention;

FIGS. 8A-8D are different views of an aerogel holder of a first design;

FIGS. 9A-9D are different views of an aerogel holder of a second design;

FIGS. 10A-10D are different views of an aerogel holder of a third design;

FIGS. 11A-11D are different views of an aerogel holder of a fourth design;

FIGS. 12A-12D are different views of an aerogel holder of a fifth design;

FIGS. 13A-13D are different views of an aerogel holder of a sixth design;

FIGS. 14A-14D are different views of an aerogel holder of a seventh design;

FIGS. 15A-15D are different views of an aerogel holder of an eighth design;

FIGS. 16A-16D are different views of an aerogel holder of a ninth design;

FIGS. 17A-17C are different views of a modular aerogel holder in accordance with certain embodiments of the invention;

FIG. 18A is a broken-away, perspective view of a spacer for an aerogel-containing IG unit in accordance with one embodiment of the invention; FIG. 18B is an end view of the spacer of FIG. 18A;

FIG. 19A is a broken-away, perspective view of a spacer for an aerogel-containing IG unit in accordance with another embodiment of the invention; FIG. 19B is an end view of the spacer of FIG. 19A;

FIG. 20A is a broken-away, perspective view of a spacer for an aerogel-containing IG unit in accordance with still another embodiment of the invention; FIG. 20B is an end view of the spacer of FIG. 20A;

FIG. 21 is a schematic, cross-sectional side view of a double-pane insulating glazing unit in accordance with certain embodiments of the invention;

FIG. 22 is a schematic, cross-sectional side view of a double-pane insulating glazing unit in accordance with other embodiments of the invention;

FIG. 23 is a schematic, cross-sectional side view of a double-pane insulating glazing unit in accordance with still other embodiments of the invention;

FIG. 24 is a schematic, cross-sectional side view of a double-pane insulating glazing unit in accordance with yet other embodiments of the invention;

FIG. 25 is a broken-away, schematic, cross-sectional side view of a glazing assembly comprising a multiple-pane insulating glazing unit mounted in a frame in accordance with certain embodiments of the present invention;

FIG. 26 is a cross-sectional side view of various spacer configurations that can be used in a first group of embodiments of the invention;

FIG. 27A is a broken-away, perspective view of a spacer for an aerogel-containing IG unit in accordance with an embodiment of the invention; FIG. 27B is an end view of the spacer of FIG. 27A;

FIG. 28 is a schematic, cross-sectional side view of a double-pane insulating glazing unit in accordance with certain embodiments of the invention;

FIG. 29A is a broken-away, perspective view of a spacer for an aerogel-containing IG unit in accordance with another embodiment of the invention; FIG. 29B is an end view of the spacer of FIG. 29A;

FIG. 30 is a schematic, cross-sectional side view of a double-pane insulating glazing unit in accordance with certain embodiments of the invention;

FIG. 31 is a broken-away, schematic, cross-sectional side view of a glazing assembly comprising a multiple-pane insulating glazing unit mounted in a frame in accordance with certain embodiments of the invention;

FIG. 32 is an end view of a spacer for an aerogel-containing IG unit in accordance with certain embodiments of the invention;

FIG. 33 is a cross-sectional side view of a double-pane insulating glazing unit in accordance with certain embodiments of the invention;

FIG. 34 is a cross-sectional side view of a double-pane insulating glazing unit in accordance with other embodiments of the invention;

FIG. 35 is a cross-sectional side view of a double-pane insulating glazing unit in accordance with still other embodiments of the invention;

FIG. 36 is a cross-sectional side view of a double-pane insulating glazing unit in accordance with yet other embodiments of the invention;

FIG. 37 is a cross-sectional side view of a triple-pane insulating glazing unit in accordance with certain embodiments of the invention;

FIG. 38 is a cross-sectional side view of a triple-pane insulating glazing unit in accordance with other embodiments of the invention;

FIG. 39 is a cross-sectional side view of a triple-pane insulating glazing unit in accordance with still other embodiments of the invention;

FIG. 40 is a cross-sectional side view of a triple-pane insulating glazing unit in accordance with yet other embodiments of the invention;

FIG. 41 is a cross-sectional side view of a triple-pane insulating glazing unit in accordance with still other embodiments of the invention;

FIG. 42 is a cross-sectional side view of a triple-pane insulating glazing unit in accordance with yet other embodiments of the invention;

FIG. 43 is a cross-sectional side view of a triple-pane insulating glazing unit in accordance with still other embodiments of the invention;

FIG. 44 is a cross-sectional side view of a triple-pane insulating glazing unit in accordance with yet other embodiments of the invention;

FIG. 45 is a cross-sectional side view of a triple-pane insulating glazing unit in accordance with still other embodiments of the invention;

FIG. 46 is a perspective view of a spacer for an aerogel-containing IG unit in accordance with certain embodiments of the invention;

FIG. 47 is an end view of a spacer for an aerogel-containing IG unit in accordance with other embodiments of the invention;

FIG. 48 is a perspective view of a spacer for an aerogel-containing IG unit in accordance with still other embodiments of the invention;

FIG. 49 is a schematic shape table showing front views of seventy-two different shape options that can be used for a pane or an IG unit in accordance with certain embodiments of the invention;

FIGS. 50-55 are a series of schematic cross-sectional side views collectively illustrating a series of method steps performed in a manufacturing method according to certain embodiments of the invention;

FIGS. 56-59 are another series of schematic cross-sectional side views collectively illustrating another series of method steps performed in a manufacturing method according to some embodiments of the invention;

FIG. 60A is a partially broken-away cross-sectional side view of an aerogel sheet holder joined to a spacer so as to support an aerogel sheet in accordance with certain embodiments of the invention;

FIG. 60B is a partially broken-away cross-sectional side view of another aerogel sheet holder joined to a spacer so as to support an aerogel sheet in accordance with other embodiments of the invention; and

FIG. 61 is a flow chart depicting a method in accordance with certain embodiments of the invention.

### SUMMARY OF THE INVENTION

Some embodiments provide a multiple-pane insulating glazing unit that includes first and second panes, a spacer, an aerogel sheet, and an aerogel sheet holder. The spacer maintains the first and second panes in a spaced-apart configuration, such that a between-pane space is located between the first and second panes. In the present embodiments, the aerogel sheet is located in the between-pane space and carried alongside the second pane by the aerogel sheet holder.

In certain embodiments, the invention provides a glazing assembly that includes a frame and an IG unit mounted in the frame such that a vision area is located inwardly of the frame. The IG unit includes first and second panes, a spacer, an aerogel sheet, and an aerogel sheet holder. The spacer maintains the first and second panes in a spaced-apart configuration, such that a between-pane space is located between the first and second panes. In the present embodiments, the aerogel sheet is located in the between-pane space and carried alongside the second pane by the aerogel sheet holder, such that the aerogel sheet holder is located outside of the vision area.

Certain embodiments of the invention provide a multiple-pane insulating glazing unit that includes first and second panes, a spacer, and an aerogel sheet. The spacer maintains the first and second panes in a substantially parallel spaced-apart arrangement with a between-pane space located between the first and second panes. In the present embodiments, the spacer has a seating structure carrying the aerogel sheet in a seated position within the between-pane space. In some of these embodiments, the spacer has an inside wall and opposed first and second sidewalls, with the first and second sidewalls being sealed respectively to first and second panes.

In some embodiments where the spacer has a seating structure, the aerogel sheet has an edge carried against an inside wall of the spacer, the aerogel sheet has opposed first and second sides, and the seating structure engages at least one of the first and second sides of the aerogel sheet. In certain embodiments of this nature, the seating structure includes a mounting rib or mounting shoulder, which engages only one of the first and second sides of the aerogel sheet. The aerogel sheet in such embodiments can optionally be sandwiched between the mounting rib or mounting shoulder and one of the first and second panes. Furthermore, it can optionally be the case that there is no adhesive between the aerogel sheet and the pane it is engages.

In certain embodiments where the spacer has a seating structure, the seating structure bounds a channel, an edge region of the aerogel sheet is received in the channel, the aerogel sheet has opposed first and second sides, and the seating structure engages both the first and second sides of the aerogel sheet. In such embodiments, the spacer can optionally include an inside wall that defines a base of the channel. Furthermore, in some embodiments of this nature, the spacer includes an outside wall, and the channel is a recessed channel such that the base of the channel is closer to the outside wall than is the rest of the spacer's inside wall.

Some embodiments of the invention provide an insulating glazing unit that includes first and second panes, a spacer, and an aerogel sheet. The spacer has an inside wall and opposed first and second sidewalls. The first and second sidewalls of the spacer are sealed respectively to the first and second panes. The spacer thereby maintains the first and second panes in a substantially parallel spaced-apart arrangement with a between-pane space located between the first and second panes. The inside wall of the spacer is exposed to the between-pane space. In the present embodiments, the spacer defines a seating structure carrying the aerogel sheet in a seated position alongside, yet spaced apart from, the second pane.

In certain embodiments, the invention provides a spacer for an aerogel-containing IG unit. The spacer has an inside wall and opposed first and second sidewalls. The first and second sidewalls of the spacer are configured to be sealed respectively to first and second panes of the aerogel-containing IG unit so as to retain the first and second panes in a substantially parallel spaced-apart arrangement. The inside wall of the spacer is configured to be exposed to a between-pane space of the aerogel-containing IG unit. In the present embodiments, the spacer has a seating structure configured to carry an aerogel sheet in a seated position alongside, yet spaced apart from, the second pane.

Some embodiments of the invention provide a multiple-pane insulating glazing unit that includes first and second panes, a spacer, and an aerogel sheet. Preferably, the spacer maintains the first and second panes in a substantially parallel spaced-apart arrangement with a between-pane space located between the first and second panes. In the present embodiments, the spacer has a seating structure that facilitates retaining the aerogel sheet in a seated position within the between-pane space.

In some embodiments, the invention provides a multiple-pane insulating glazing unit that includes first and second panes, a spacer, and an aerogel sheet. The aerogel sheet has a perimeter edge and opposed first and second faces. Preferably, the spacer maintains the first and second panes in a substantially parallel spaced-apart arrangement with a between-pane space located between the first and second panes. In the present embodiments, the spacer has a seating structure such that the aerogel sheet is sandwiched between the seating structure of the spacer and a desired one of the first and second panes. Furthermore, the aerogel sheet can optionally have a major dimension that is smaller than a corresponding major dimension of the desired one of the first and second panes, such that a perimeter edge of the aerogel sheet is set back inwardly from a perimeter edge of the desired one of the first and second panes.

Certain embodiments of the invention provide a spacer for an aerogel-containing IG unit. The spacer has an inside wall and opposed first and second sidewalls. The inside wall of the spacer includes a base portion that faces a between-pane space of the aerogel-containing IG unit when operatively assembled. The first and second sidewalls of the spacer are sealant beds for sealant to seal the spacer to first and second panes of the aerogel-containing IG unit so as to retain the first and second panes in a substantially parallel spaced-apart arrangement. In the present embodiments, the spacer has a seating structure configured to support an aerogel sheet in a seated position within the between-pane space of the aerogel-containing IG unit when operatively assembled. Preferably, the seating structure projects inwardly relative to the base portion, such that when the aerogel-containing IG unit is operatively assembled the seating structure projects into the between-pane space.

In some embodiments, the invention provides a method of manufacturing a multiple-pane insulating glazing unit. The method includes providing an aerogel sheet on a surface of a pane, and adhering a spacer onto a perimeter of the pane such that the aerogel sheet is sandwiched between the pane and a seating structure of the spacer.

Certain embodiments of the invention provide a method of manufacturing a multiple-pane insulating glazing unit. In the present embodiments, the method involves a preliminary glazing assembly, which includes a first pane, an aerogel sheet alongside a surface of the first pane, and a spacer adhered to a perimeter of the first pane. The method includes adhering a second pane to the spacer such that a gas gap is created between the aerogel sheet and the second pane.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

In the present specification, anywhere the terms “comprising” or “comprises” are used, those terms have their ordinary, open-ended meaning. In addition, where appropriate, the disclosure at each such location is to be understood to also disclose that it may, as an alternative, “consist essentially of” or “consist of.”

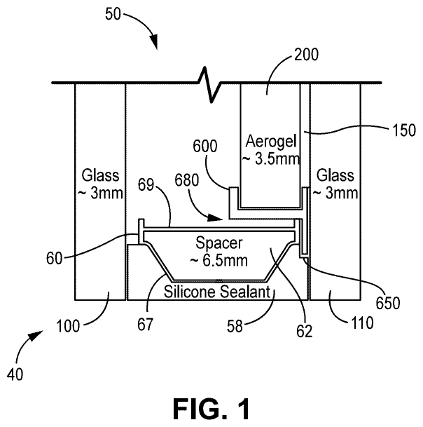

In a first group of embodiments, the invention provides a multiple-pane insulating glazing unit comprising first and second panes, a spacer, an aerogel sheet, and an aerogel sheet holder. FIGS. 1-7 depict various embodiments of this nature. The spacer 60 maintains the first and second panes in a spaced-apart configuration, such that a between-pane space 50 is located between the first and second panes. Such first and second panes may be the only two panes of an IG unit 40, or they may be any two adjacent panes of an IG unit 40. The aerogel sheet 200 is located in the between-pane space 50 and carried alongside the second pane by the aerogel sheet holder 600.

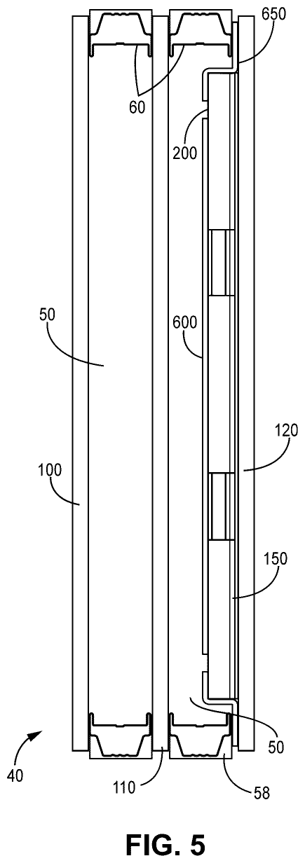

In the present embodiment group, the multiple-pane insulating glazing unit 40 preferably is either a double-pane unit or a triple-pane unit. Thus, the noted first and second panes may be the only two panes of the unit or it may further include one or more other panes. As non-limiting examples, FIGS. 1-4 show double-pane IG unit embodiments, whereas FIGS. 5-7 show triple-pane IG unit embodiments. In FIGS. 1-4, there is only a single between-pane space 50. Furthermore, there is preferably only a single spacer 60. In FIGS. 5-7, there are two between-pane spaces 50, which are located on opposite sides a central pane. Furthermore, there preferably are two spacers 60. In other triple-pane IG unit embodiments, though, a single spacer is used to hold all three panes in their spaced-apart configuration. Various spacers of this nature are well known and can be used for triple-pane IG unit embodiments.

In some cases, the (or each) between-pane space 50 contains a thermally insulative gas mix, such as a mix of 90% argon and 10% air. This, however, is not required. For example, the IG unit 40 can alternatively be filled with air or a desired single gas. Moreover, if desired, the (or each) between-pane space 50 can be evacuated to a desired vacuum level, such as a moderate vacuum level, so as to further enhance the thermal insulation properties of the IG unit 40.

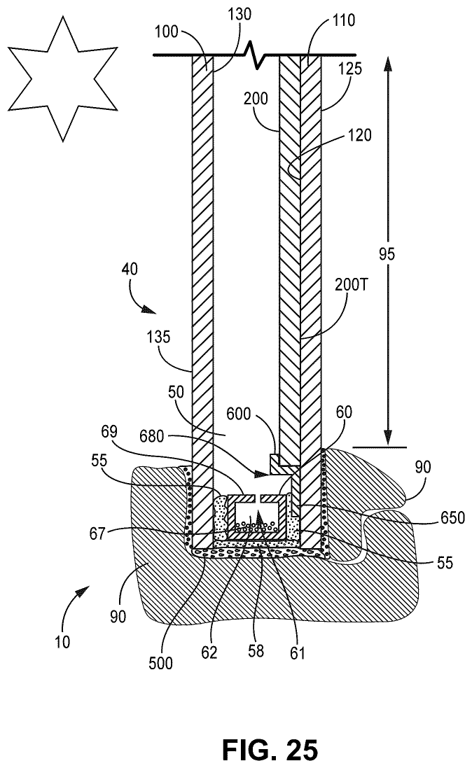

In the embodiments of FIGS. 1-4, the aerogel sheet holder 600 carries the aerogel sheet 200 alongside pane 110. In certain embodiments of this nature, pane 110 is configured to be an inboard pane (e.g., it can be mounted as part of a glazing assembly so as to be an inboard pane: see FIG. 25), such that pane 100 is configured to be an outboard pane (e.g., it can be mounted as part of a glazing assembly so as to be an outboard pane). In such cases, there can optionally be a low-emissivity coating on the interior surface (i.e., the #2 surface) of pane 100.

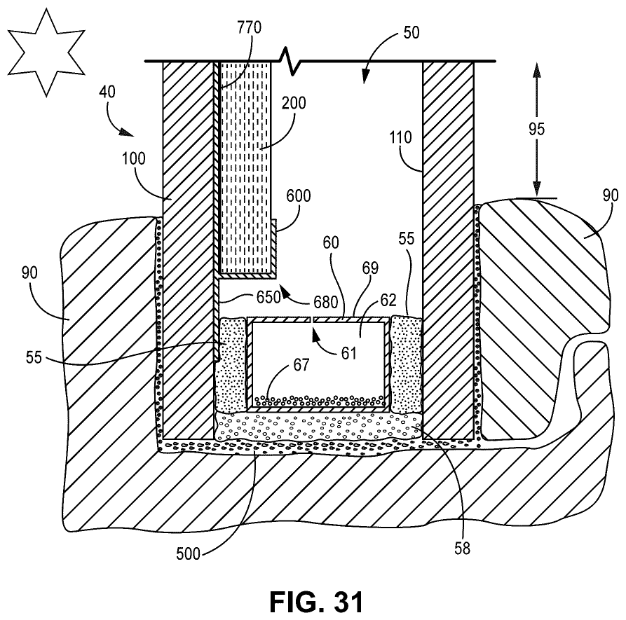

In other cases, the aerogel sheet 200 is carried alongside the interior surface of pane 100. Reference is made to the embodiment of FIG. 31. Here, an optional low-emissivity coating 770 is shown on the interior surface (i.e., the #2 surface) of pane 100. In a variant of the configuration shown in FIG. 31, a mounting gap (not shown in FIG. 31) is added between pane 100 and the aerogel sheet 200. In such cases, when the illustrated low-emissivity coating 770 is provided, it bounds the mounting gap on one side while the aerogel sheet 200 bounds the mounting gap on an opposite side.

In the embodiment of FIG. 5, a first spacer 60 maintains panes 100, 110 in a spaced-apart configuration, such that a first between-pane space 50 is located between panes 100, 110, while a second spacer 60 maintains panes 110, 1200 in a spaced-apart configuration, such that a second between-pane space 50 is located between panes 110, 1200. In this particular embodiment, an aerogel sheet 200 is located in the second between-pane space 50 and carried alongside pane 1200 by the aerogel sheet holder 600. In embodiments of this nature, pane 1200 can optionally be configured to be an inboard pane (e.g., it can be mounted as part of a glazing assembly so as to be an inboard pane), such that pane 100 is configured to be an outboard pane (e.g., it can be mounted as part of a glazing assembly so as to be an outboard pane). In such cases, there can optionally be a low-emissivity coating on the interior surface (i.e., the #2 surface) of pane 100. Additionally or alternatively, there may be a low-emissivity coating on the interior surface of pane 1200. Another possibility is to provide a low-emissivity coating on one or both surfaces of pane 110. Or there may be no low-emissivity coating on any of the panes.

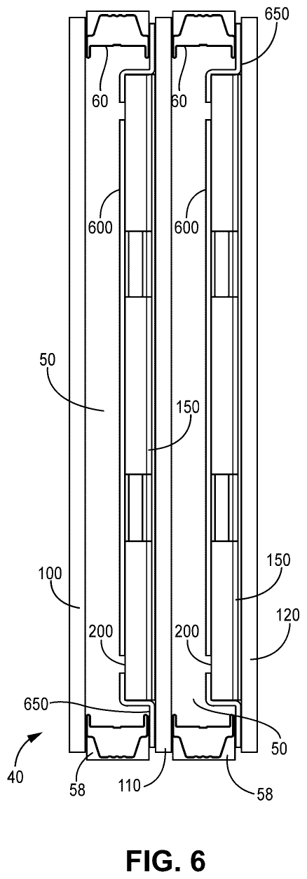

In the embodiment of FIG. 6, a first spacer 60 maintains panes 100, 110 in a spaced-apart configuration, such that a first between-pane space 50 is located between panes 100, 110, while a second spacer 60 maintains panes 110, 1200 in a spaced-apart configuration, such that a second between-pane space 50 is located between panes 110, 1200. In this embodiment, a first aerogel sheet 200 is located in the first between-pane space 50 and carried alongside pane 110 by a first aerogel sheet holder 600, while a second aerogel sheet 200 is located in the second between-pane space 50 and carried alongside pane 1200 by a second aerogel sheet holder 600. In embodiments of this nature, pane 1200 can optionally be configured to be an inboard pane (e.g., it can be mounted as part of a glazing assembly so as to be an inboard pane), such that pane 100 is configured to be an outboard pane (e.g., it can be mounted as part of a glazing assembly so as to be an outboard pane). In such cases, there can optionally be a low-emissivity coating on the interior surface (i.e., the #2 surface) of pane 100. Additionally or alternatively, there may be a low-emissivity coating on the interior surface of pane 1200. Another possibility is to provide a low-emissivity coating on one or both surfaces of pane 110. Or there may be no low-emissivity coating on any of the panes.

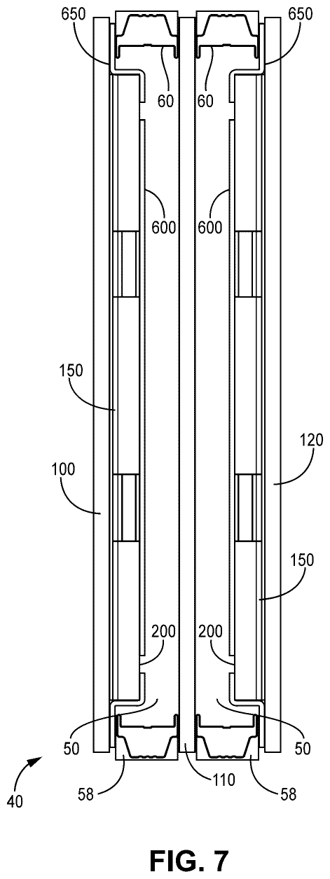

In the embodiment of FIG. 7, a first spacer 60 maintains panes 100, 110 in a spaced-apart configuration, such that a first between-pane space 50 is located between panes 100, 110, while a second spacer 60 maintains panes 110, 1200 in a spaced-apart configuration, such that a second between-pane space 50 is located between panes 110, 1200. In this embodiment, a first aerogel sheet 200 is located in the first between-pane space 50 and carried alongside pane 100 by a first aerogel sheet holder 600, while a second aerogel sheet 200 is located in the second between-pane space 50 and carried alongside pane 1200 by a second aerogel sheet holder 600. In embodiments of this nature, pane 1200 can optionally be configured to be an inboard pane (e.g., it can be mounted as part of a glazing assembly so as to be an inboard pane), such that pane 100 is configured to be an outboard pane (e.g., it can be mounted as part of a glazing assembly so as to be an outboard pane). In such cases, low-emissivity coating can optionally be provided on one or both surfaces of pane 110. Additionally or alternatively, there may be low-emissivity coating on the interior surface of pane 100, on the interior surface of pane 1200, or both. Or there may be no low-emissivity coating on any of the panes.

A variety of known glass types can be used for the panes, including soda-lime glass, borosilicate glass, or aluminosilicate glass. In some cases, it may be desirable to use “white glass,” a low iron glass, etc. For some applications, it may be desirable to use tinted glass for one or more of the panes. Moreover, there may be applications where one or more of the panes are formed of extremely thin, flexible glass, such as glass sold under the trademark Willow glass by Corning Inc. (Corning, New York, U.S.A.). If desired, one or more of the panes may be formed of a chemically strengthened glass, such as glass sold under the trademark Gorilla glass by Corning. In certain embodiments, the panes are part of a window, door, skylight, or other glazing. In some cases, the panes are part of a window insert or interior window designed to be retrofitted to an inside of an existing window. Exemplary window inserts are sold as Indow Inserts (Indow, Oregon, U.S.A.) or ComfortSEAL Interior Windows (Larson Manufacturing, South Dakota, U.S.A.). In alternative embodiments, one or more of the panes are sheets of a polymer, such as polycarbonate, acrylic, or PVC. Various other polymer materials (e.g., transparent polymers) may be used in such alternative embodiments. Preferably, though, the panes are sheets of glass.

Glass sheets of various sizes can be used. Commonly, large-area glass sheets are used. For example, each of the panes can be a glass sheet having a major dimension (e.g., a length or width) of at least about 0.1 meter, preferably at least about 0.5 meter, more preferably at least about 1 meter, perhaps more preferably at least about 1.5 meters (e.g., between about 2 meters and about 4 meters).

Glass sheets of various thicknesses can be used. In some embodiments, each of the panes is a glass sheet having a thickness of about 1-8 mm. In some cases, each of the panes is a glass sheet having a thickness of between about 2.3 mm and about 4.8 mm, and perhaps more preferably between about 2.5 mm and about 4.8 mm. In certain non-limiting examples, each of the panes is a glass sheet having a thickness of about 3 mm.

As noted above, the IG unit 40 includes a spacer 60. In the embodiments shown in FIGS. 1-4, the IG unit 40 is shown with a single spacer 60. In the embodiments shown in FIGS. 5-7, the IG unit 40 is shown with two spacers 60. As noted above, however, another option for triple-pane IG unit embodiments is to provide a single spacer that holds all three panes in their spaced-apart configuration.

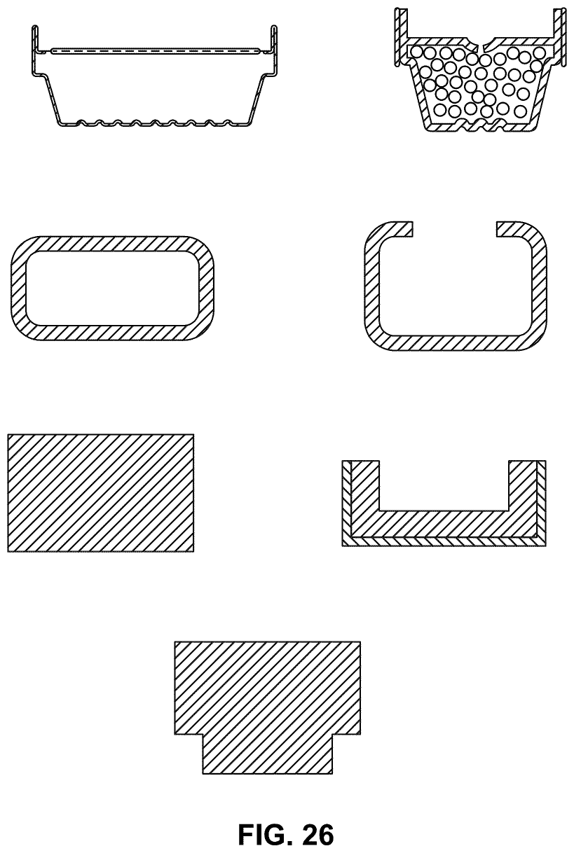

Many different types of spacers can be used in the present embodiment group. FIG. 26 shows several non-limiting examples of spacer types that may be used. In some cases, the (or each) spacer 60 comprises or consists of a metal, such as stainless steel or another alloy, aluminum, titanium or another aircraft metal, or some other suitable metal. Reference is made to the first four spacer profiles shown in FIG. 26. Alternatively, the (or each) spacer 60 can consist of a polymer (e.g., foam). Reference is made to the fifth and seventh spacer profiles shown in FIG. 26. In other cases, the spacer can comprise both metal and polymer. For example, a plastic spacer body can be provided with a metal moisture barrier layer. Reference is made to the sixth spacer profile shown in FIG. 26. Still another possibility is to use a spacer with top and bottom walls of metal and sidewalls of plastic.

The spacer (or each spacer) 60 can optionally be a conventional metal channel spacer, e.g., formed of stainless steel or aluminum. Various spacers of this nature are commercially available, for example, from Allmetal, Inc. (Itasca, Illinois, U.S.A.). The spacer(s) can alternatively be an integral part of a sash, frame, etc.

In certain embodiments, the spacer 60 has an interior space 62 in which desiccant 67 is received. Preferably, the spacer 60 has an inside wall 69 that faces a gas gap of a between-pane space 50. Furthermore, the inside wall 69 of the spacer 60 preferably has a plurality of apertures 61 that extend from the interior space 62 of the spacer to the gas gap, e.g., such that the desiccant 67 in the interior space of the spacer is in gaseous communication with the gas gap. Suitable spacers of this nature are detailed in U.S. Pat. No. 8,789,343, entitled “Glazing Unit Spacer Technology,” the contents of which are incorporated herein by reference.

The spacer 60 can be adhered to two panes 100, 110 by one or more beads of sealant 55, 58, as is conventional and well-known to a person of ordinary skill in this technology area. If desired, the (or each) spacer can have a primary sealant (e.g., sealant 55) on opposite sides of the spacer and a secondary sealant (e.g., sealant 58) on an outside wall of the spacer. Reference is made to the non-limiting examples of FIGS. 25 and 31. Another option is to simply provide a single deposit of sealant that covers both sides of the spacer and the outside wall of the spacer. Various other known sealant arrangements/systems can be used.

In the non-limiting examples of FIGS. 25 and 31, each illustrated IG unit 40 includes both: (i) two beads of primary sealant 55, and (ii) a deposit of secondary sealant 58. In embodiments of this nature, the primary sealant may comprise polyisobutylene (“PIB”), optionally carbon-filled PIB, while the secondary sealant comprises silicone. It is to be appreciated, however, that various other sealant materials can be used. Polysulphide or polyurethane, for example, can be used as a secondary sealant.

Rather than having a double-seal system, the IG unit can have a single-seal system. More generally, any IG unit 40 of the present disclosure can be provided with any desired sealing system, e.g., any known single-seal system or any known double-seal system.

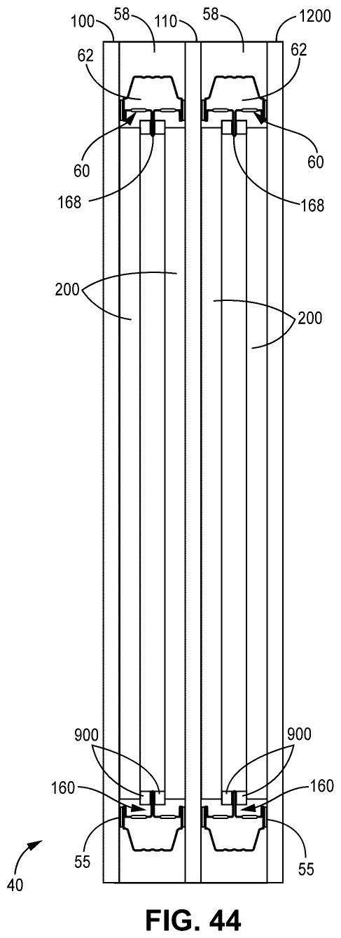

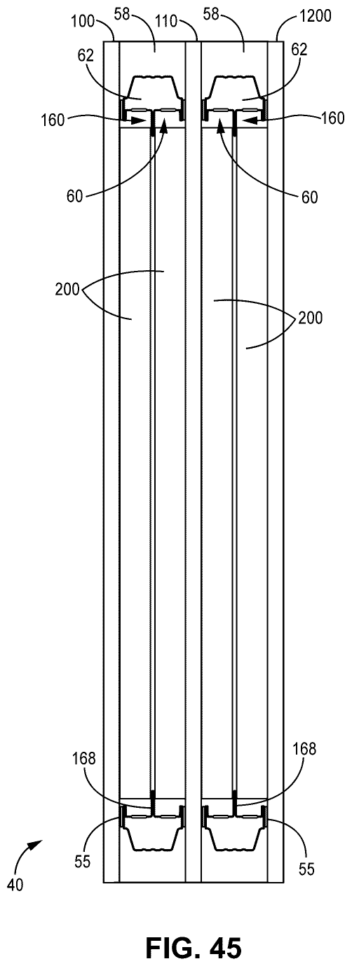

The multiple-pane insulating glazing unit 40 includes an aerogel sheet 200, which is carried alongside (and in some cases, contacts) an interior surface of one of the panes. In the embodiments shown in FIGS. 1-5, the IG unit 40 is shown with a single aerogel sheet 200. In the embodiments shown in FIGS. 6 and 7, the IG unit 40 is shown with two aerogel sheets 200. In the embodiments shown in FIGS. 44 and 45, the IG unit 40 is shown with four aerogel sheets 200.

The (or each) aerogel sheet 200 has a thickness. In some embodiments, the thickness of the (or each) aerogel sheet 200 is in a range of from 1.5 mm to 21 mm, such as greater than 2 mm but less than 15 mm, or in a range of from 2 mm to 4 mm (e.g., 3-3.5 mm). It is to be appreciated, however, that other thicknesses can be used.

The (or each) aerogel sheet 200 preferably has a length of at least 0.1 meter, such as at least 0.5 meter, or perhaps at least 1 meter (e.g., between 1.5 meters and 4 meters). In many embodiments, the (or each) aerogel sheet 200 has a length of at least 0.5 meter and a width of at least 0.3 meter. In some examples, the length is greater than 0.9 meter while the width is greater than 0.6 meter. Thus, the (or each) aerogel sheet 200 can advantageously be a large-area aerogel sheet. Moreover, for any embodiment of the present disclosure, the dimensions of the (or each) aerogel sheet 200 can optionally be within any one or more of the ranges noted in this paragraph. Other dimensions can be used, however, to meet the requirements of different glazing applications.

The (or each) aerogel sheet 200 may have a length and a width that are respectively less than a length and a width of the pane alongside which such aerogel sheet is carried. This can optionally be the case for any embodiment of the present disclosure. Further, the length and the width of the (or each) aerogel sheet 200 can optionally be respectively less than a length and a width of the aerogel sheet holder 600. Still further, the length and the width of the (or each) aerogel sheet holder 600 can optionally be respectively less than the length and the width of the adjacent pane.

An alternative is to have the length and the width of the (or each) aerogel sheet holder be respectively the same as the length and the width of the adjacent pane. In such cases, there may be one bead of sealant between a mounting flange of the aerogel sheet holder and the adjacent pane, while another bead of sealant is provided between the aerogel sheet holder and the adjacent side of the spacer. As one example, the mounting flange 650 shown in FIG. 25 can be extended so as to terminate flush with the edge of pane 110 and an additional bead of sealant can be added between that extended mounting flange and pane 110. As another example, the mounting flange 650 shown in FIG. 31 can be extended so as to terminate flush with the edge of pane 100 and an additional bead of sealant can be added between that extended mounting flange and pane 100.

The aerogel sheet(s) 200 can comprise a silica-based aerogel or a polymer-based aerogel. In some cases, silica-based aerogel is used. In such cases, the aerogel sheet(s) 200 can advantageously be produced, and can have properties, in accordance with U.S. patent application Ser. Nos. 18/636,553 and 18/636,591 and 18/636,411 and 18/636,421 and 18/636,464 and 18/636,497 and 18/636,681 and 18/636,715 and 18/637,947 and 18/637,975 and 18/638,006 and 18/638,201 and 18/637,769 and 18/637,850 and 18/637,818 and 18/637,885, the contents of each of which are hereby incorporated by reference. In still other cases, the aerogel is a cellulose-based aerogel. Aerogels of this nature are described in U.S. Patent Application Publication No. US2019/0055373, entitled “Bacterial Cellulose Gels, Process for Producing and Methods of Use,” the teachings of which are incorporated herein by reference. In such cases, the aerogel can contain cellulosic nanocomposites that are aligned in ordered liquid crystal phases. Various other aerogel materials are commercially available or otherwise known; any suitable aerogel material can be used.

The present aerogel is in the form of a sheet. This is in contrast to aerogel in flowable granular or other particulate form. The (or each) aerogel sheet 200 preferably is self-supporting, i.e., once fully synthesized and formed, it can retain its sheet form without being adhered to glass or another support. It is to be appreciated, however, that once incorporated into the IG unit 40, the (or each) aerogel sheet 200 preferably is supported by one or more of an aerogel sheet holder 600, a spacer 60, and one or more panes. As illustrated, the IG unit 40 preferably does not include any cell or honeycomb structure surrounding/containing particulate aerogel.

The (or each) aerogel sheet 200 has opposed major surfaces (or “faces”). In some cases, one face of the (or each) aerogel sheet 200 is carried alongside (optionally so as to contact) an interior surface of one of the panes, while the other face of the (or each) aerogel sheet is exposed to a gas gap of a between-pane space 50. In the embodiment of FIG. 25, for example, a face 200T of the aerogel sheet 200 is in contact with pane 110.

Preferably, the peripheral edge of the (or each) aerogel sheet 200 is located within a between-pane space 50 of the IG unit 40. This is preferably the case along the entire perimeter of the (or each) aerogel sheet 200.

In the present embodiment group, the IG unit 40 includes an aerogel sheet holder 600. In FIGS. 1-5, the IG unit 40 is shown with a single aerogel sheet holder 600. In FIGS. 6 and 7, the IG unit 40 is shown with two aerogel sheet holders 600. The following discussion describes various optional features and configurations with reference to a single aerogel sheet holder. It is to be appreciated, however, that when two holders are provided, either or both of them can optionally have the features and configurations described below.

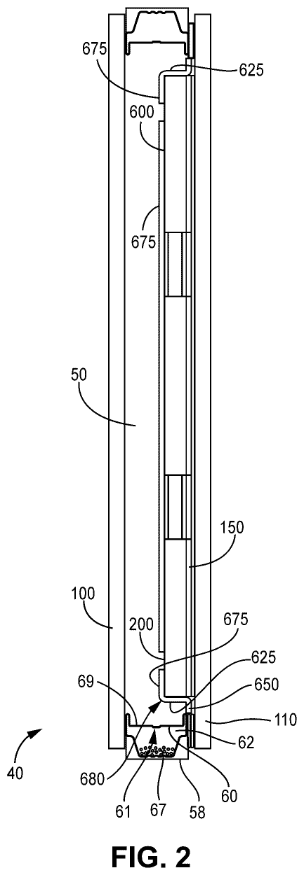

In some embodiments of the present group, part of the aerogel sheet holder 600 is sandwiched between a spacer 60 and a pane 100, 110, or 1200. Reference is made to FIG. 1. Here, the aerogel sheet holder 600 includes a mounting flange 650, which is sandwiched between the spacer 60 and pane 110. This is also shown in FIGS. 2-4. Another embodiment of this nature is shown in FIG. 25. Still another such embodiment is shown in FIG. 31.

In other cases, the mounting flange of the aerogel sheet holder can be omitted. For example, an aerogel sheet holder similar to the one shown in FIG. 1 but with the mounting flange 650 omitted can be provided. In such cases, a sealant or an adhesive can bond a side of the aerogel sheet holder to the adjacent pane.

In FIGS. 1-4, sealant is located between the spacer 60 and pane 110, and an optional mounting flange 650 of the aerogel sheet holder 600 is in contact with the sealant. This is also the case in the embodiment of FIG. 25. Similarly, in FIG. 31, sealant is located between the spacer 60 and pane 100, and an optional mounting flange 650 of the aerogel sheet holder 600 is in contact with the sealant.

In the present embodiment group, the aerogel sheet 200 preferably does not contact (is spaced apart from) the spacer 60. This is the case for the double-pane IG unit embodiments of FIGS. 1-4. Furthermore, in embodiments like those of FIGS. 5-7 where there are multiple spacers 60 and/or multiple aerogel sheets 200, each aerogel sheet 200 preferably does not contact (is spaced apart from) each spacer 60.

In the present group of embodiments, the spacer 60 has a width, the aerogel sheet holder 600 has a width, and the width of the aerogel sheet holder preferably is smaller than the width of the spacer. Reference is made to the non-limiting examples of FIGS. 1-7. In some cases, the width of the aerogel sheet holder 600 is less than half the width of the spacer 60. Reference is made to FIGS. 2-7. This is not required, however, as shown in FIG. 1. Similarly, the (or each) aerogel sheet holder 600 in FIGS. 2-7 can alternatively be dimensioned to have a width that is more than half the width of the (or each) spacer 60. In some non-limiting examples, the width of the aerogel sheet holder 600 is in a range of 30-70% (or 40-60%) of the width of the spacer 60.

In some cases, the (or each) aerogel sheet 200 has a thickness that is less than the width of the (or each) aerogel sheet holder 600. Reference is made to FIGS. 1, 2, 25, and 31. It is to be appreciated, however, that this is not required.

In certain embodiments of the present group, the aerogel sheet holder 600 is secured against a pane (e.g., pane 110), yet a mounting gap 150 exists between that pane and the aerogel sheet 200. This is shown, for example, in FIGS. 1 and 2. Here, the illustrated aerogel sheet holder 600 includes a mounting flange 650 that is secured against a pane (e.g., pane 110), yet a mounting gap 150 exists between that pane and the aerogel sheet 200. In embodiments involving a mounting gap 150, there may be no contact between the aerogel sheet 200 and the adjacent pane. Alternatively, there may be at least some contact between the aerogel sheet and the pane. For example, the aerogel sheet may contact the pane only at a central region, e.g., if there is some bowing of the aerogel sheet or the like. If desired, a low-emissivity coating can be provided on the pane surface that bounds any such mounting gap 150.

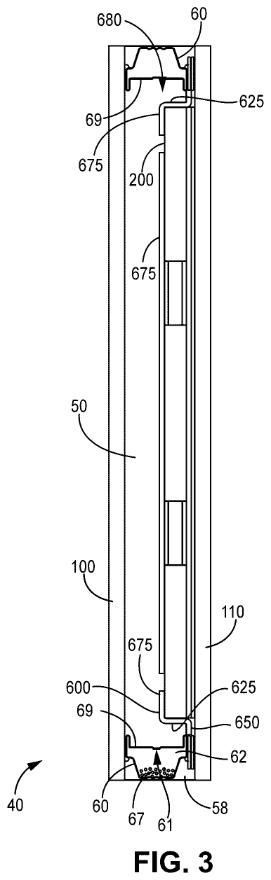

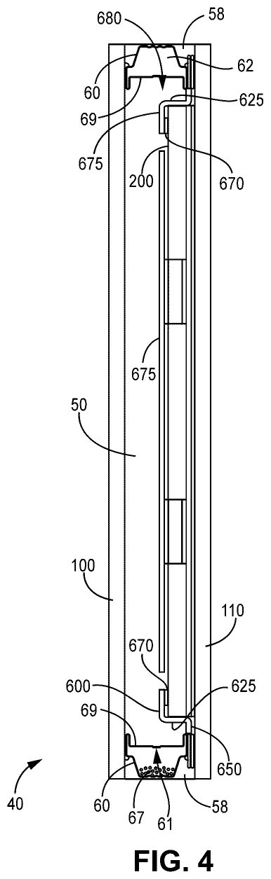

In the present embodiment group, the aerogel sheet holder 600 preferably includes a seat 680 in which an aerogel sheet 200 is received. When an aerogel sheet 200 is received in seat 680, the aerogel sheet holder 600 preferably retains the aerogel sheet alongside an adjacent pane. In FIGS. 1 and 2, as noted above, there is a mounting gap 150 between the aerogel sheet 200 and the adjacent pane. In FIGS. 3 and 4, the aerogel sheet 200 is in contact with the adjacent pane. This is also the case in FIG. 25. In such embodiments, a face 200T of the aerogel sheet 200 is carried directly against a surface of the adjacent pane.

In some cases, a mounting adhesive or sealant 670 is provided between the aerogel sheet 200 and the aerogel sheet holder 600. Reference is made to the non-limiting example of FIG. 4. Here, a mounting adhesive or sealant 670 is provided between the aerogel sheet 200 and the seat 680 of the aerogel sheet holder 600. This may be especially advantageous for embodiments where the aerogel sheet 200 is carried directly against the adjacent pane. For example, the mounting adhesive or sealant 670 may be compressible, at least when applied, e.g., so as to serve as a deformable gasket between the aerogel sheet 200 and the aerogel sheet holder 600. In other cases, mounting adhesive or sealant is provided in an embodiment like those of FIGS. 1 and 2. In such cases, the mounting adhesive or sealant can advantageously facilitate retaining the aerogel sheet in a seat of the aerogel sheet holder. When provided, the mounting adhesive or sealant 670 preferably is not in contact with the spacer 60. Instead, the mounting adhesive 670 can optionally be located only between the aerogel sheet 200 and the aerogel sheet holder 600.

In embodiments that involve a mounting gap 150 on one side of an aerogel sheet 200, a gas gap preferably exists on the other side of that aerogel sheet. In the non-limiting examples of FIGS. 1 and 2, there is a gas gap between the aerogel sheet 200 and pane 100, while a mounting gap 150 is located between the aerogel sheet and pane 110. In such cases, the mounting gap 150 has a width, the gas gap has a width, and the width of the gas gap preferably is greater than the width of the mounting gap. The width of the gas gap, for example, may be more than two times, more than three times, or even more than five times the width of the mounting gap 150.

In certain non-limiting examples, the width of the mounting gap 150 is greater than 0.01 mm but less than 0.5 mm.

Preferably, the seat 680 of the aerogel sheet holder 600 is spaced apart inwardly from the spacer 60. That is, the seat 680 of the aerogel sheet holder 600 preferably is further from the edge of the IG unit 40 than is the spacer 60. Thus, the seat 680 of the aerogel sheet holder 600 preferably is not in contact with the spacer 60. This is shown, for example, in FIGS. 1-4. Here, the aerogel sheet holder 600 includes a mounting flange 650, and the mounting flange is sandwiched between the spacer 60 and pane 110, yet the seat 680 of the aerogel sheet holder is not in contact with the spacer. In other embodiments, a seat of the aerogel sheet holder may be in contact with (e.g., attached to) the spacer.

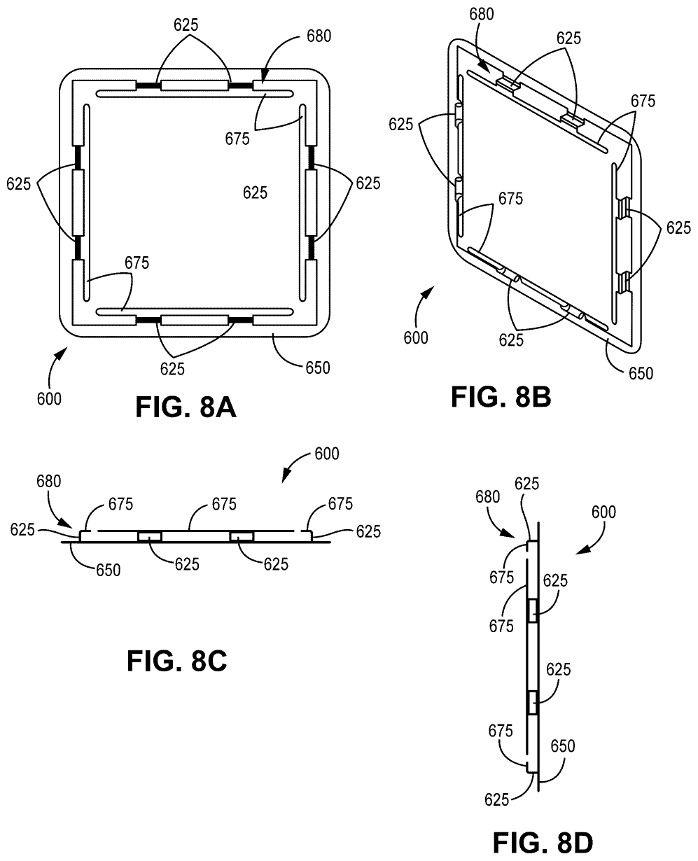

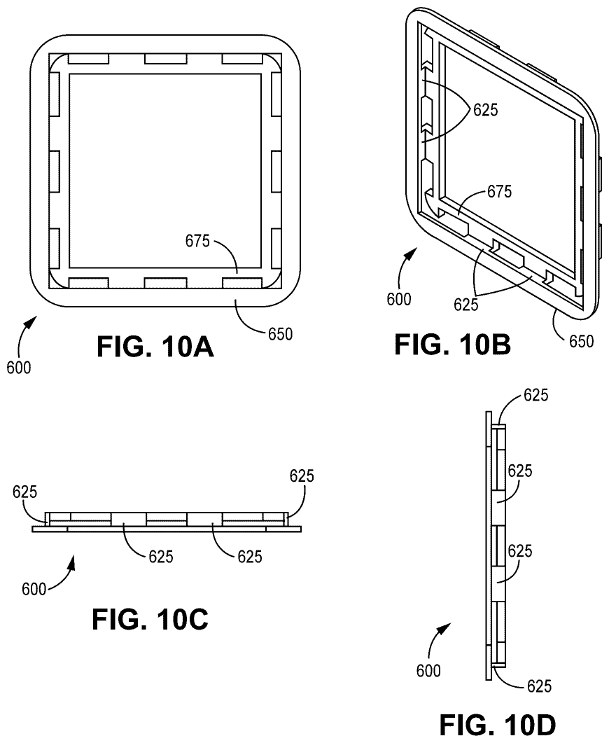

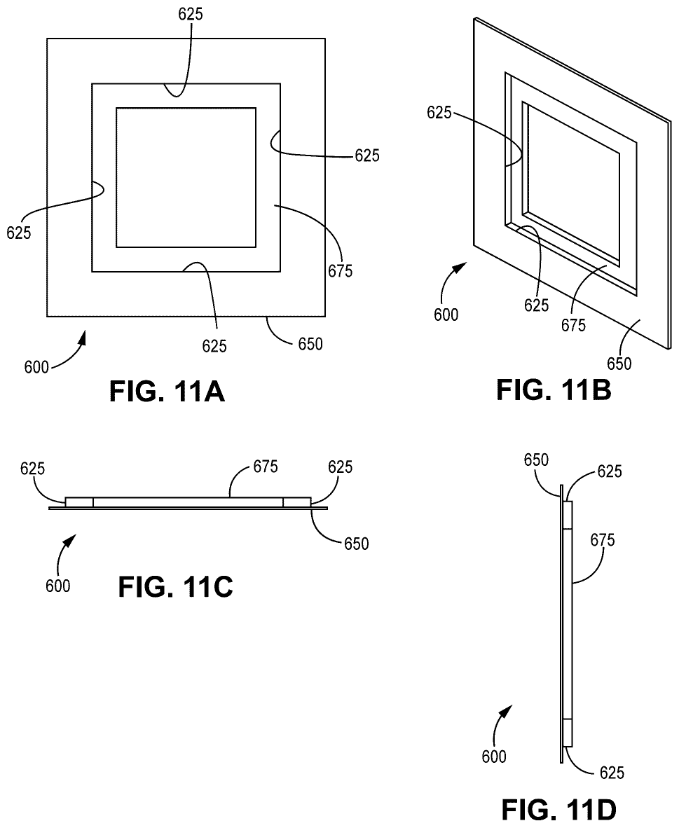

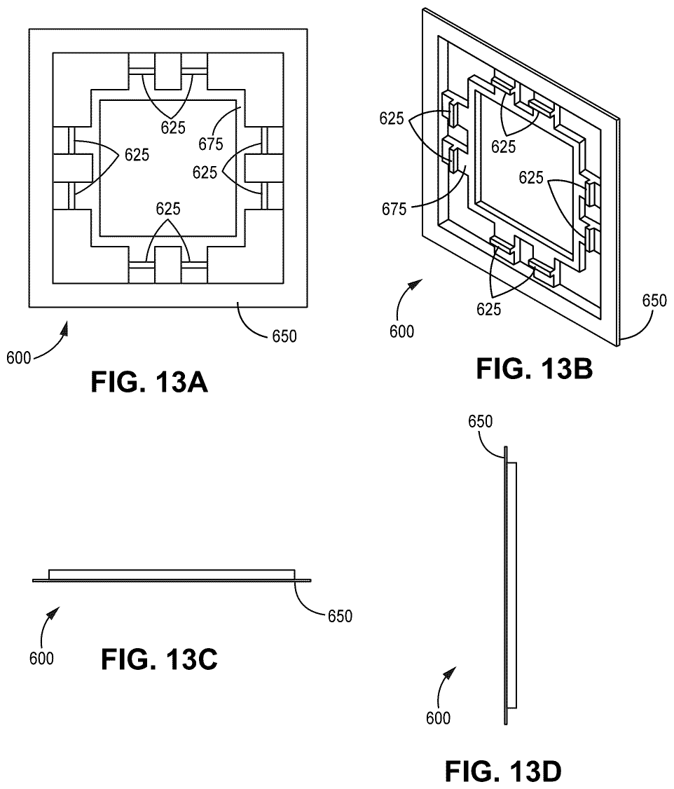

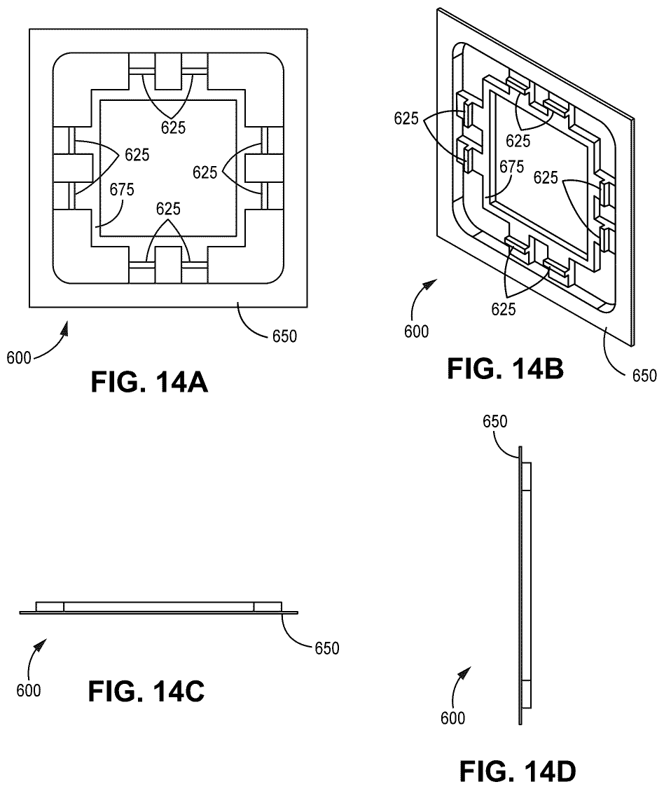

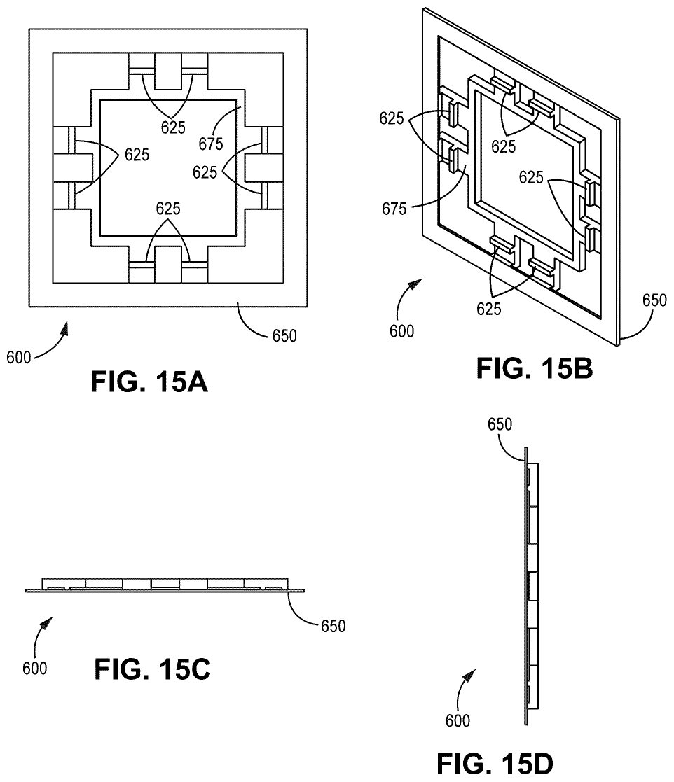

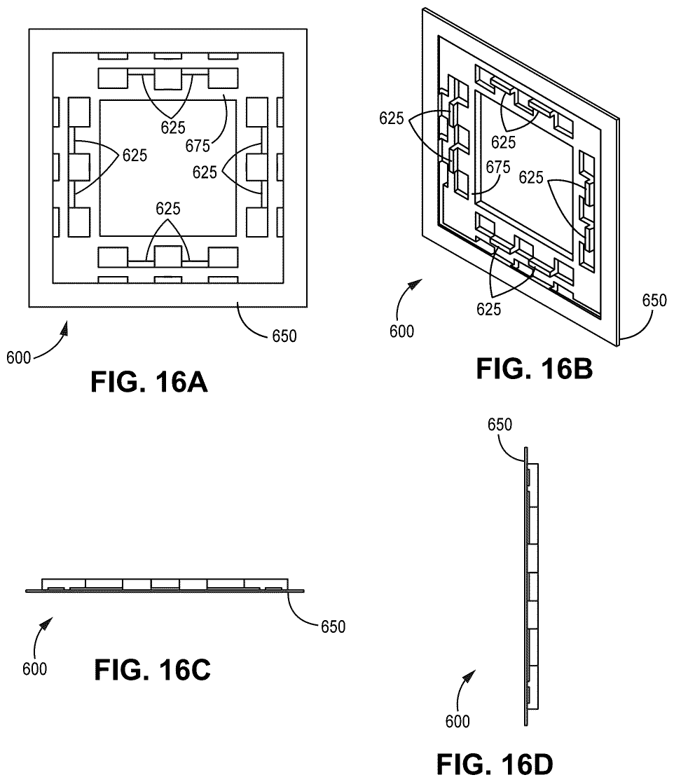

In the present embodiment group, the aerogel sheet holder 600 can be provided in various configurations. Nine different examples are shown in FIGS. 8A-16D.

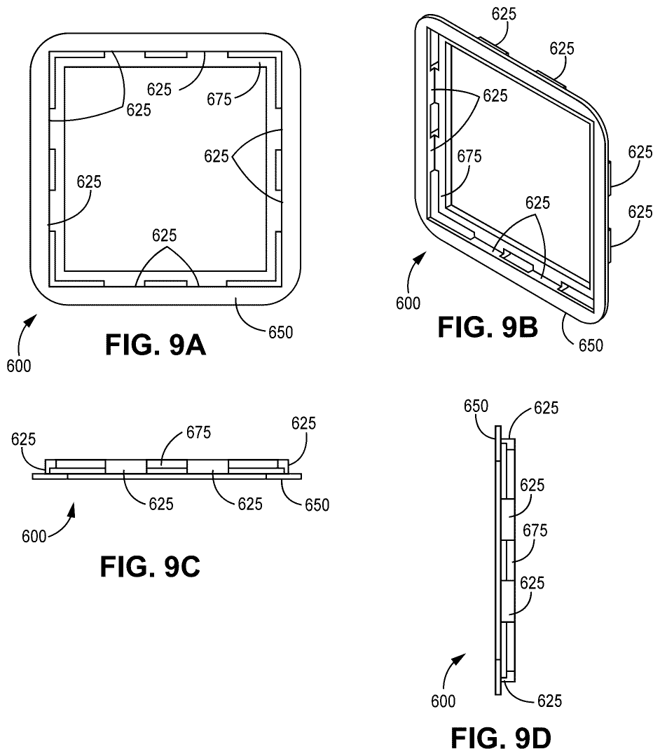

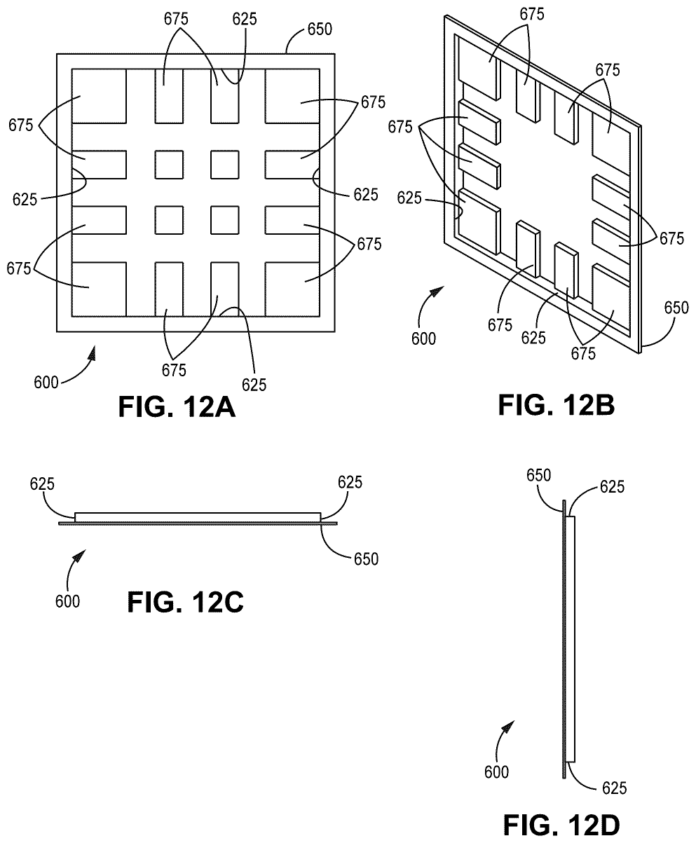

Preferably, the seat 680 of the aerogel sheet holder 600 comprises a base wall 625 and a sidewall 675. In some cases, the seat 680 has only one sidewall 675. Reference is made to FIGS. 9A-11D and 13A-16D. In other cases, the seat 680 has multiple sidewalls 675. Reference is made to FIGS. 8A-8D and 12A-12D. Either way, the seat 680 preferably has multiple base walls 625.

In the present embodiments, the (or each) base wall 625 can optionally be at least generally perpendicular (e.g., at least substantially perpendicular, such as perpendicular) to the (or each) sidewall 675.

In addition to having a seat 680, the aerogel sheet holder 600 can optionally include a mounting flange 650, as described previously. In such cases, the mounting flange 650 preferably is at least generally parallel (e.g., at least substantially parallel, such as parallel) to the sidewall(s) 675 and at least generally perpendicular to the base wall(s) 625. Moreover, the sidewall(s) 675 can optionally be at least generally parallel (e.g., at least substantially parallel, such as parallel) to the adjacent pane, and/or the base wall(s) can optionally be at least generally perpendicular (e.g., at least substantially perpendicular, such as perpendicular) to the adjacent pane. In FIGS. 2-4, the illustrated sidewalls 675 are parallel to the second pane 110, and the illustrated base walls 625 are perpendicular to the second pane.

In some of the present embodiments, there is a mounting adhesive or sealant 670 between (e.g., directly between, so as to contact both) the aerogel sheet holder 600 and the aerogel sheet 200. In the non-limiting example of FIG. 4, the mounting adhesive or sealant 670 is located only between the aerogel sheet 200 and sidewalls 675 of the aerogel sheet holder 600.

The aerogel sheet 200 has opposed front and rear sides as well as an edge (the “peripheral edge”). In the embodiments of FIGS. 1-4, the front side of the aerogel sheet 200 faces toward pane 100, and the rear side of the aerogel sheet faces toward pane 110. Here, the front side of the aerogel sheet 200 is carried against sidewalls 675 of the seat 680 of the illustrated aerogel sheet holder 600, and the edge of the aerogel sheet is carried against base walls 625 of the seat of the aerogel sheet holder.

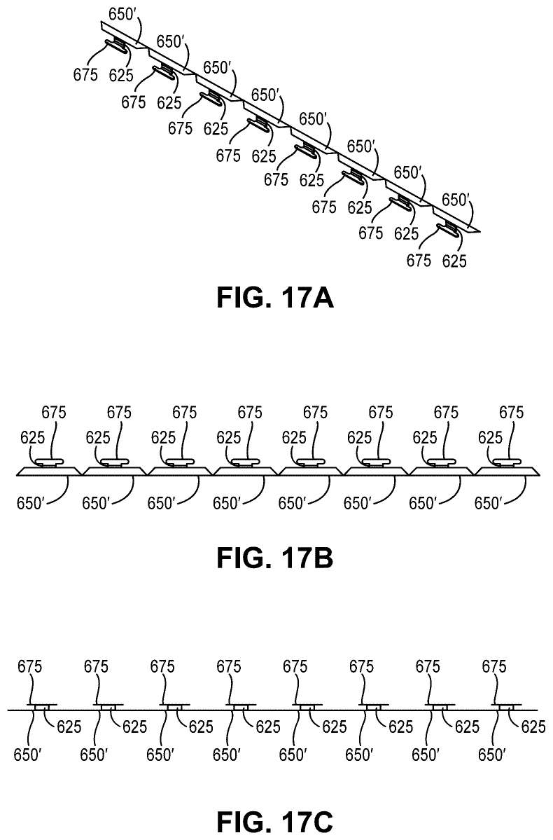

In some embodiments, the aerogel sheet holder 600 is defined by a single, integral body. This is shown in the non-limiting examples of FIGS. 8A-16D. In some cases, the aerogel sheet holder 600 comprises polymer, composite, or metal. Certain embodiments provide the aerogel sheet holder 600 in the form of a single, integral body that is a piece of sheet metal. FIGS. 17A-17C, for example, depict a modular sheet metal configuration that can be fashioned into such an aerogel sheet holder. More will be said of this later.

Certain embodiments provide an aerogel sheet holder 600 having four lengths each including a mounting flange portion 650′, one or more base walls 625, and one or more sidewalls 675. In some embodiments of this nature, for each of the four lengths of the aerogel sheet holder 600: (i) a first bend exists between the mounting flange portion 650′ and each of the one or more base walls 625, and (ii) a second bend exists between each of the one or more base walls 625 and one of the one or more sidewalls 675. In such cases, each first bend preferably is substantially a 90-degree bend, and each second bend preferably is substantially a 90-degree bend.

With reference to FIGS. 17A-17C, the aerogel sheet holder 600 can optionally comprise (e.g., be defined by) a single, integral body that is a piece of sheet metal having a length. In such cases, the piece of sheet metal preferably defines a series of modules that repeat along the length of the piece of sheet metal. Preferably, each of the modules includes a mounting flange portion 650′, a base wall 625, and a sidewall 675. In embodiments of this nature, it is possible to create a stock length of the modular sheet metal and then cut and bend it to a desired length. This may be an elegant way to provide aerogel sheet holders of different lengths in an efficient production setting.

In some embodiments of the first group, both the spacer 60 and the aerogel sheet holder 600 comprise metal. As two examples, stainless steel or aluminum can be used. Titanium or other aircraft metals may also be used. In other cases, the spacer, the aerogel sheet holder, or both are formed of polymer or composite.

With reference to FIG. 1, some non-limiting dimensions that may be suitable include the panes 100, 110 being glass sheets each with a thickness of greater than 1.5 mm and less than 5 mm, such as about 3 mm, the spacer 60 having a width of greater than 3 mm and less than 10 mm, such as about 6.5 mm, the aerogel sheet 200 having a thickness of at least 1 mm but no more than 8 mm, such as about 3.5 mm, and the aerogel sheet holder 600 having a width of greater than 1 mm and less than 9 mm, such as about 3.6-3.8 mm. It is to be appreciated that the foregoing dimensions are merely examples; they are by no means limiting.

As noted above, in some embodiments, a gas gap exists between the aerogel sheet 200 and a first pane, and the spacer 60 has an interior space 62 in which desiccant 67 is received. In such cases, the spacer 60 has an inside wall 69 that faces the gas gap. The inside wall 69 of the spacer 60 preferably has a plurality of apertures 61 that extend from the interior space 62 of the spacer to the gas gap, e.g., such that desiccant 67 in the interior space of the spacer is in gaseous communication with the gas gap. This is best seen in FIGS. 2-4, 25, and 31. (Although not visible in FIG. 1, such small openings preferably are also present in the spacer 60 of FIG. 1 as well as in the spacers 60 shown in other figures of this disclosure.) In embodiments of this nature, the aerogel sheet holder 600 preferably is configured so as not to block the gaseous communication provided by the plurality of apertures 61 in the inside wall 69 of the spacer 60.

In certain embodiments of the present group, the multiple-pane insulating glazing unit 40 is a double-pane IG unit having first 100 and second 110 panes but no other panes, and the spacer 60 has opposed first and second sides that are sealed respectively to the first 100 and second 110 panes. Reference is made to the non-limiting examples of FIGS. 1-4, 25, and 31. In double-pane IG unit embodiments, the IG unit 40 preferably has a thickness of less than 30 mm, less than 25 mm, less than 23 mm, or even less than 22 mm. For any double-pane IG unit embodiment of this disclosure, the IG unit 40 thickness can optionally be in any one or more of these ranges. The thickness of the IG unit 40 is defined as the distance between the opposed exterior pane surfaces (e.g., from surface 125 to surface 135).

In certain double-pane IG unit embodiments, the between-pane space 50 has a width in a range of from 13 to 21 mm. In such embodiments, the aerogel sheet 200 preferably has a thickness of greater than 2 mm but less than 8 mm, or from 2-4 mm. Furthermore, in some embodiments of this nature, the gaseous atmosphere comprises argon, air, or both, and the gas gap has a width in a range of from 9 to 14 mm.

In another group of embodiments, the invention provides a glazing assembly 10 that includes a frame 90 and a multiple-pane insulating glazing unit 40 mounted in the frame. Reference is made to the non-limiting examples of FIGS. 25 and 31. In each of these figures, the illustrated IG unit 40 includes two panes 100, 110, a spacer 60, an aerogel sheet 200, and an aerogel sheet holder 600. The IG unit 40 in the present embodiments can be of the nature described above. For example, it can be a triple-pane IG unit or a double-pane IG unit.

In some of the present embodiments, the frame 90 supports the IG unit 40 in a vertical orientation. FIGS. 25 and 31 show non-limiting examples of this nature. In other embodiments of the present group, the frame supports the IG unit in a horizontal orientation or an inclined orientation.

The frame 90 can be a sash or any other type of frame structure suitable for embracing an IG unit. A wide variety of conventional frames are known.

In the present embodiments, the frame 90 can be formed of (or can include) various materials. In some cases, the frame 90 includes wood, vinyl, or both. Various types of wood window frames are known. Likewise, various types of vinyl window frames are known. If desired, the frame 90 can be vinyl clad wood. More generally, the frame 90 can have any known construction and composition suitable for holding the multiple-pane IG unit 40.

In some cases, the frame 90 is part of a wall of a building. In many such cases, the exterior surface of the outboard pane is exposed to an outdoor environment (and thus exposed to periodic contact with rain), while the exterior surface of the inboard pane is exposed to an indoor environment within a house or another building. Reference is made to the non-limiting example of FIGS. 25 and 31.

Preferably, the glazing assembly 10 further includes a seal 500 between the frame 90 and the IG unit 40. When provided, the optional seal 500 may comprise a bedding sealant. In such cases, any conventional bedding sealant composition and positioning may be used.

In the present group of embodiments, the IG unit 40 is mounted in the frame 90 such that the glazing assembly 10 has a vision area 95. Preferably, the aerogel sheet 200 has a peripheral edge located entirely outside of the vision area 95. Moreover, the aerogel sheet holder 600 preferably is located entirely outside of the vision area 95. This is shown in the non-limiting examples of FIGS. 25 and 31.

As used herein, the term “vision area” refers to the area of the IG unit 40 through which a person is able to see once the IG unit is mounted operably in a frame 90. In FIGS. 25 and 31, the vision area 95 of an IG unit 40 mounted in a frame 90 is shown. In embodiments where the IG unit 40 is mounted in a frame 90, the frame may delineate the vision area 95, such that the vision area is the area inward from an innermost interior edge of the frame.

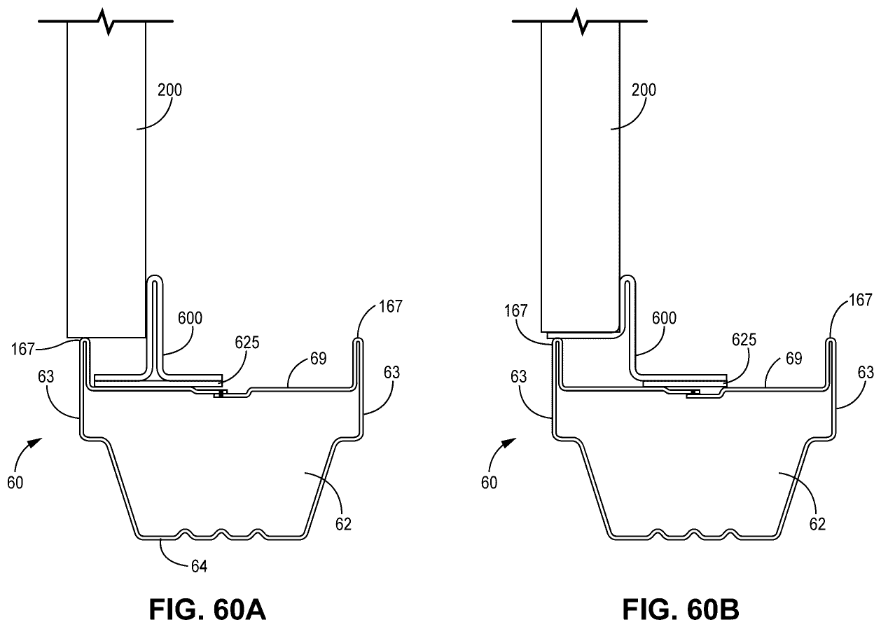

FIGS. 60A and 60B show two examples of an aerogel sheet holder 600 that is attached to an inside wall 69 of a spacer 60 so as to support an aerogel sheet 200 in an IG unit. For illustration purposes, FIGS. 60A and 60B do not show the two panes of the IG unit. It is to be appreciated, however, that this type of holder 600 can be used in any IG unit embodiment shown elsewhere in this disclosure. With continued reference to FIGS. 60A and 60B, it can be appreciated that the illustrated holder 600 is attached to the inside wall 69 of the spacer 60 by an adhesive 625. When provided, the adhesive 625 preferably does not outgas, or at least not substantially. One example is a double-sided acrylic foam tape, such as the 3M VHB tape sold commercially by 3M Company (St. Paul, Minnesota, U.S.A.). Rather than using adhesive, a holder of this nature can be welded to the inside wall of a spacer. Another option is to provide a snap-fit of the holder onto an inside wall of a spacer, such as a snap-fit between the optional illustrated ears 167 of a spacer. As noted elsewhere, the ears 167 are optional; one or both of them are omitted in some cases.

Thus, certain embodiments provide an assembly comprising a spacer 60 and an aerogel sheet holder 600 attached to an inside wall 69 of the spacer. Furthermore, some embodiments provide an IG unit that includes such an assembly, with the holder supporting an aerogel sheet against a desired pane of the IG unit.

In a further group of embodiments, the invention provides a multiple-pane insulating glazing unit comprising first and second panes, a spacer, and an aerogel sheet. In the present embodiment group, the spacer 60 itself has (e.g., defines) a seating structure 160 supporting and/or carrying the aerogel sheet 200 in a seated position.

In the present embodiment group, the spacer 60 maintains the first and second panes in a substantially parallel spaced-apart arrangement, with a between-pane space 50 located between the first and second panes. Such first and second panes may be the only two panes of the multiple-pane insulating glazing unit 40, or they may be any two adjacent panes of the unit 40. In more detail, the seating structure 160 supports and/or carries the aerogel sheet 200 in a seated position within the between-pane space, e.g., alongside one of the panes.

Preferably, the spacer 60 has an inside wall 69 that is exposed to the noted between-pane space 50 of the IG unit 40. In some embodiments, the spacer 60 has opposed first and second sidewalls 63 that are sealed respectively to the first and second panes and thereby maintains the first and second panes in the substantially parallel spaced-apart arrangement, with the between-pane space 50 located between the first and second panes.

The aerogel sheet 200 has an edge (the “peripheral edge”), which in some embodiments is carried against (and/or abuts, optionally with a gap or sealant therebetween) an inside wall 69 of the spacer 60. Furthermore, the aerogel sheet 200 has opposed first and second sides (or “faces”), and the seating structure 160 preferably supports and/or engages at least one of the first and second sides of the aerogel sheet.

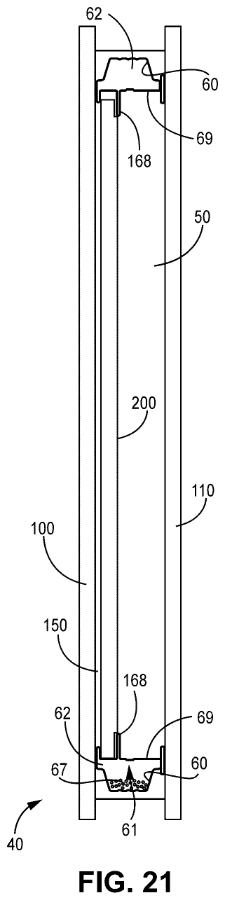

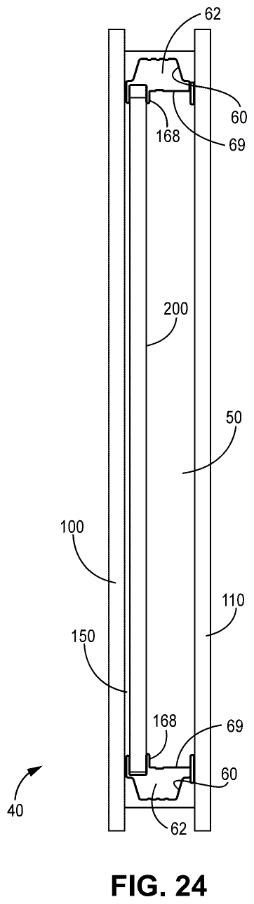

In some of the present embodiments, the spacer's seating structure 160 supports and/or carries the aerogel sheet 200 in a seated position alongside the second pane. In certain embodiments of this nature, the seating structure 160 carries the aerogel sheet 200 in a seated position alongside, yet spaced apart from, the second pane. Five embodiments of this nature are shown in FIGS. 21-24 and 30.

Preferably, the multiple-pane insulating glazing unit 40 is either a double-pane IG unit or a triple-pane IG unit. Thus, the noted first and second panes may be the only two panes of the IG unit or it may further include one or more other panes. Furthermore, there may be only a single between-pane space, or there may be two between-pane spaces. Similarly, there may be only a single spacer, or there may be two spacers. It is to be appreciated that in some triple-pane IG unit embodiments, a single spacer is used to hold all three panes in their spaced-apart configuration.

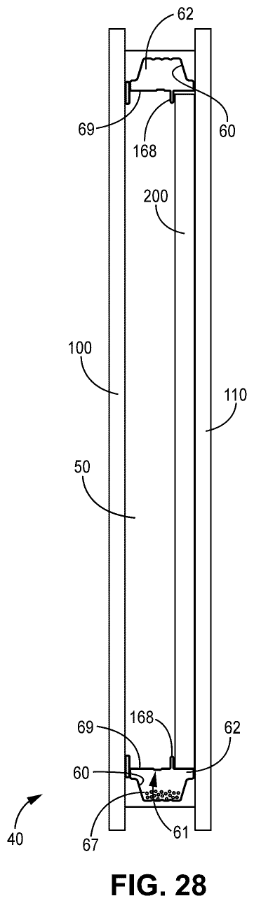

The aerogel sheet 200 has opposed first and second sides (or “faces”). The first side of the aerogel sheet faces toward the first pane, and the second side of the aerogel sheet faces toward the second pane. In the embodiments of FIGS. 21-24, 28, and 30, the first side of the aerogel sheet 200 faces toward pane 100, and the second side of the aerogel sheet faces toward pane 110. In some cases, the seating structure 160 of the spacer 60 engages (e.g., contacts or otherwise supports) both the first and second sides of the aerogel sheet 200. Five different examples of this are shown in FIGS. 21-24 and 30. In other cases, the spacer has a seating structure that engages one side of the aerogel sheet while the other side of the aerogel sheet engages only the second pane. Reference is made to the non-limiting example of FIG. 28.

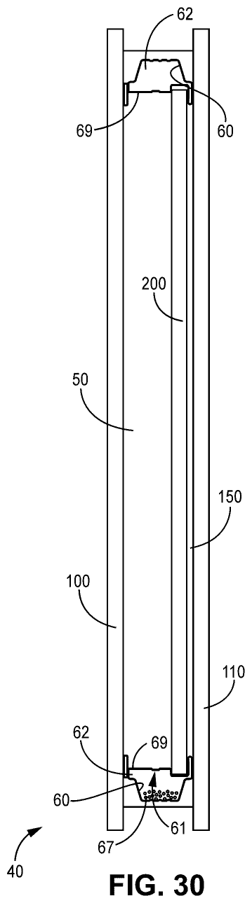

In an embodiment like that shown in FIG. 28, a low-emissivity coating can optionally be added to one or both interior surfaces of the two illustrated panes. The same is true for an embodiment like that shown in FIG. 30.

In some embodiments of the present group, a single body defines the seating structure 160 of the spacer 60. For example, a single body defining part (or all) of the spacer 60 can optionally define the entire seating structure 160. If desired, the spacer 60 can be a single body, e.g., a single body of metal (e.g., a sheet of metal), polymer (e.g., foam), or composite.

In some cases, the spacer 60 alone embraces the aerogel sheet 200 so as to retain the aerogel sheet in a seated position alongside the second pane. In FIGS. 21-24, for example, only the seating structure 160 of the spacer 60 embraces the aerogel sheet 200 so as to retain the aerogel sheet in a seated position alongside, yet spaced apart from, pane 100. Similarly, in FIG. 30, only the seating structure 160 of the spacer 60 embraces the aerogel sheet 200 so as to retain the aerogel sheet in a seated position alongside, yet spaced apart from, pane 110. Thus, FIGS. 21-24 and 30 are examples of embodiments where there is a mounting gap 150.

As noted above, in embodiments involving a mounting gap 150, there may be no contact between the aerogel sheet 200 and the adjacent pane. Alternatively, there may be at least some contact between the aerogel sheet and the pane. For example, the aerogel sheet may contact the pane only at a central region, e.g., if there is some bowing of the aerogel sheet or the like.

Preferably, the aerogel seating structure 160 is defined, at least in part, by the inside wall 69 of the spacer 60. In the embodiments shown in FIGS. 21-24, 28, and 30 for example, the aerogel seating structure 160 is defined, entirely, by the inside wall 69 of the spacer 60. This, however, is not required. In some cases, the inside wall 69 of the spacer 60 is formed of metal, such as aluminum or stainless steel. In other cases, it is formed of polymer or composite.

With respect to the configuration of the seating structure 160, it preferably: (i) bounds a mounting channel 162 or another mounting seat, (ii) includes a mounting rib 168 or a mounting shoulder, or (iii) both (i) and (ii).

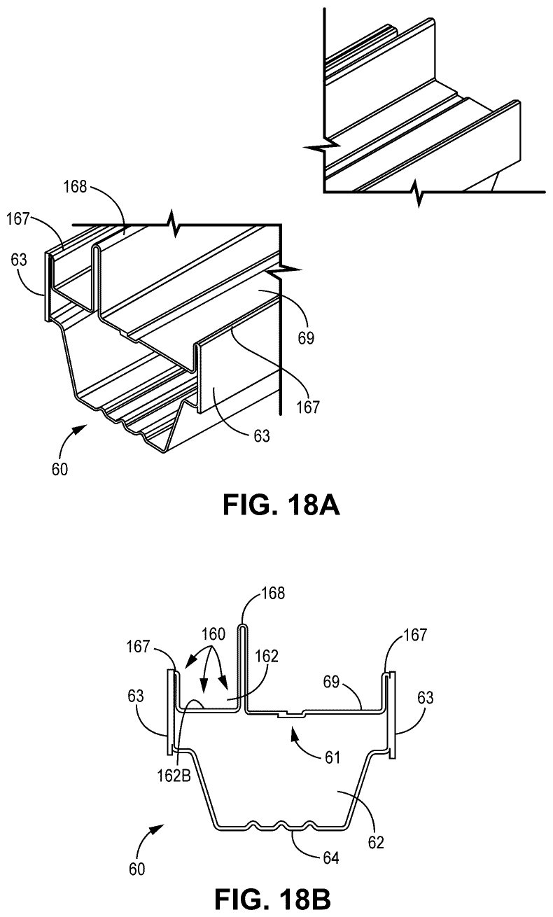

Thus, in some of the present embodiments, the seating structure 160 of the spacer 60 bounds a mounting channel 162 in which an edge region of the aerogel sheet 200 is received. Various different spacer 60 configurations can be used to provide such a channel 162. This is perhaps best appreciated by referring to FIGS. 21-24 and 30 (showing IG unit embodiments) in view of FIGS. 18A-20B and 29A-29B (showing spacer embodiments).

In FIGS. 21-24 and 30, the illustrated spacer 60 includes first and second ear portions 167, which are respectively defined, at least in part, by interior regions of the spacer's first and second sidewalls 63. Here, one of the illustrated ear portions bounds a side of the channel 162. It is to be appreciated, however, that these details are by no means limiting. For example, one or both of the ear portions 167 can be omitted. In the embodiment of FIG. 28, for example, the spacer 60 has only one ear portion 167.

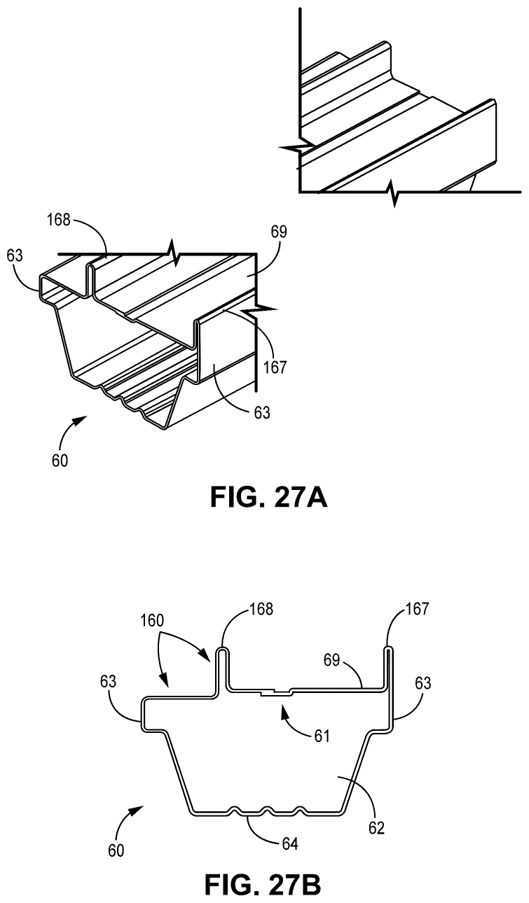

In some embodiments of the present group, the spacer 60 includes an upstanding mounting rib 168. Three non-limiting examples of such a mounting rib 168 are shown in FIGS. 18A-20B. In these examples, the mounting rib 168 bounds a side of the illustrated channel 162. In more detail, the illustrated channel 162 is bounded on one side by the mounting rib 168 while being bounded on the other side by the second ear portion 167 of the spacer. In other embodiments, one or both ear portions 167 of the spacer 60 are omitted, such that there is an L-shaped mounting seat (e.g., a laterally open L-shaped mounting seat) along one side of the mounting rib 168. Reference is made to FIG. 27. More generally, the spacer can have different seating structures that provide mounting seats of various configurations.

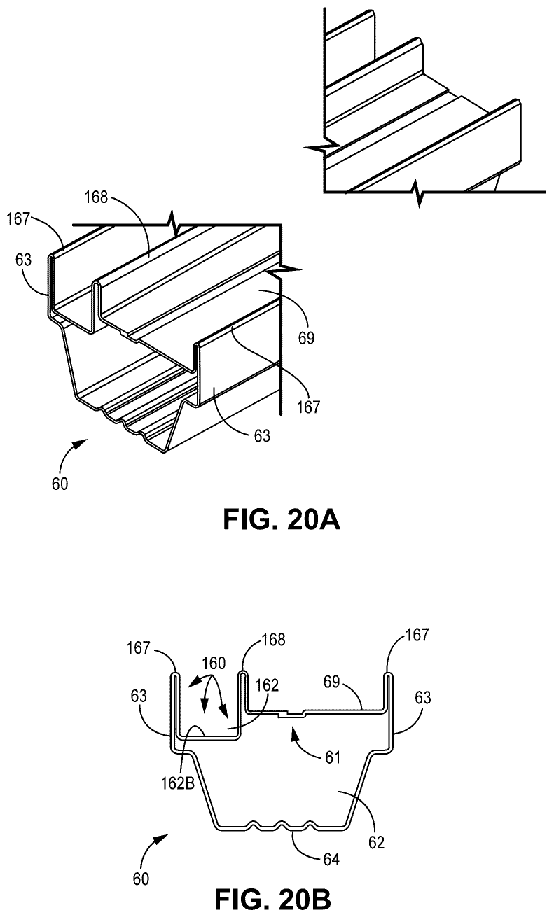

In certain embodiments, the spacer includes one or two ear portions 167 as well as a mounting rib 168, and the mounting rib has a height equal to or shorter than the height(s) of the one or two ear portions 167. Reference is made to FIGS. 20A-20B, 24, 27A-27B, and 28. Embodiments of this nature may be particularly convenient when it is desirable to provide a mounting rib 168 outside the vision area of a glazing assembly comprising the IG unit. In other cases, however, the illustrated car portion(s) 167 are omitted.

In certain embodiments involving a mounting rib 168, it has a height greater than the height(s) of first and second car portions 167 of the spacer 60. Reference is made to FIGS. 18A-19B and 21-23. Embodiments of this nature may also be used when providing the mounting rib 168 outside the vision area of a glazing assembly comprising the IG unit. Here again, one or both of the illustrated ear portions 167 can optionally be omitted.

When provided, the mounting rib 168 can optionally be formed of metal. In some embodiments, for example, the inside wall 69 of the spacer 60 is formed of metal, and the optional mounting rib 168 is an integral projection of the spacer's metal inside wall. It is to be appreciated, however, that the optional mounting rib can alternatively be formed of polymer or composite.

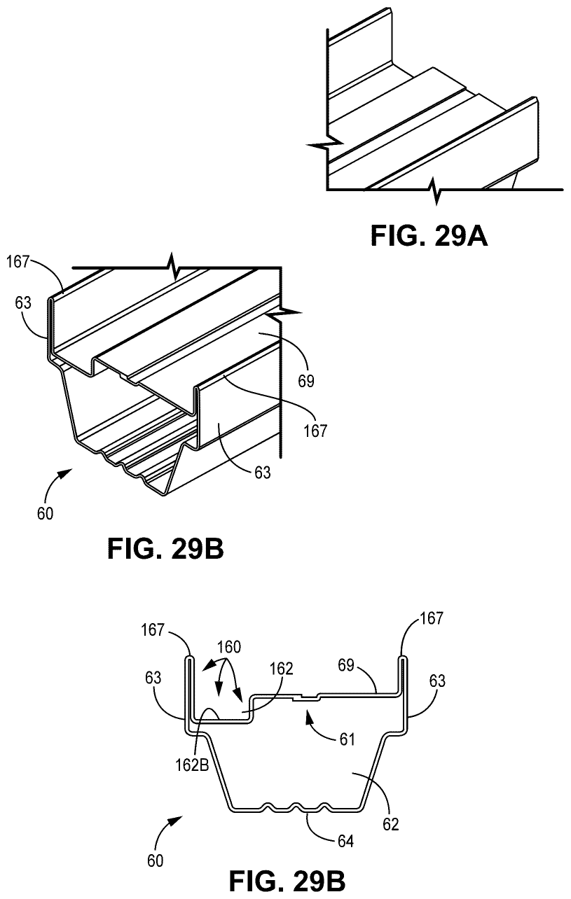

In other embodiments, rather than having a mounting rib, the spacer can have a mounting shoulder that bounds a seat (e.g., an L-shaped seat) for an aerogel sheet. Reference is made to FIGS. 29A-29B and 30. Various spacer configurations can be used to provide such a mounting shoulder. In some cases, an aerogel sheet is sandwiched directly between a mounting shoulder of the spacer and a pane of the IG unit. In other cases, an aerogel sheet is received in a channel bounded by both a mounting shoulder and an ear portion of the spacer.

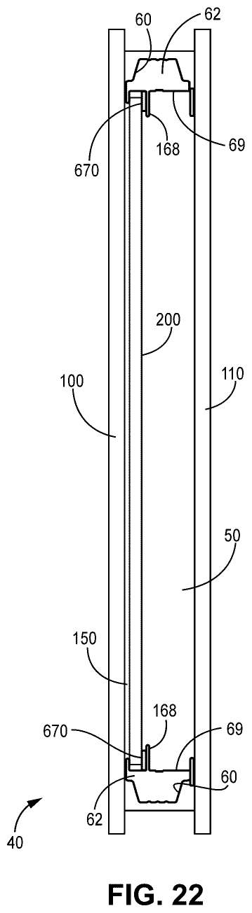

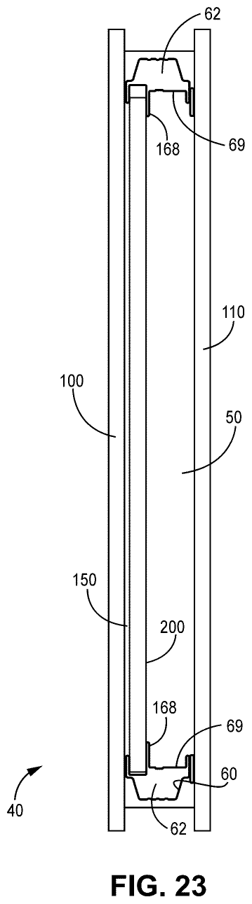

In certain embodiments of the present group, a mounting adhesive or sealant 670 is provided between the aerogel sheet 200 and the spacer's mounting structure 160. Reference is made to the non-limiting example of FIG. 22. Here, a mounting adhesive or sealant 670 is provided between the aerogel sheet 200 and an upstanding mounting rib 168 of the illustrated spacer 60. In other cases, such a mounting adhesive or sealant is added to an embodiment like those of FIG. 23, 24, 28, or 30. As illustrated, however, there is no mounting adhesive or sealant between the aerogel sheet 200 and the spacer's mounting structure 160 shown in FIGS. 21, 23, 24, 28, and 30.

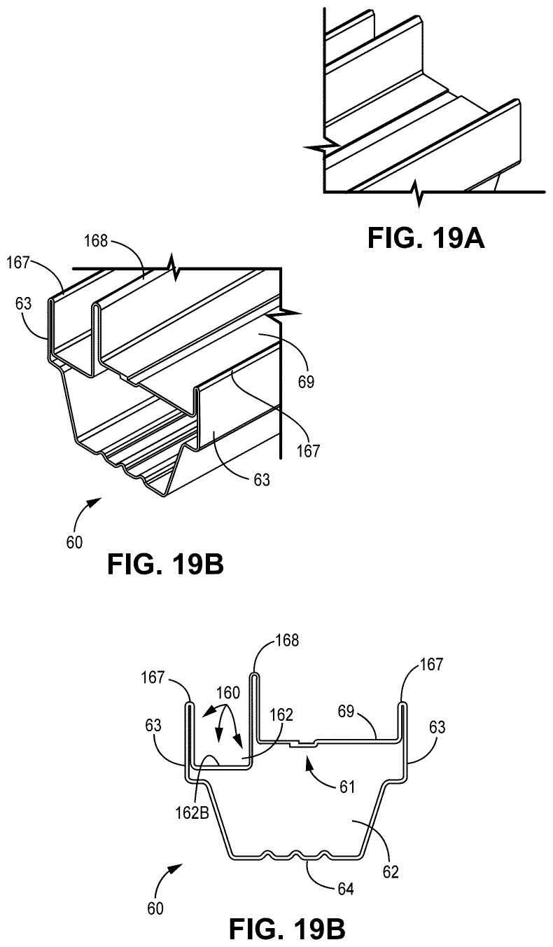

Some embodiments of the present group involve a channel 162 having a base 162B. When provided, the base 162B of such a channel can be defined by a portion of the spacer's inside wall 69. In FIGS. 19A-19B, 20A-20B, 23, 24, 29A-29B, and 30, the portion of the inside wall 69 that defines the base 162B is closer to the spacer's outside wall 64 than is the rest of the inside wall 69. This is referred to herein as a recessed channel.

Thus, in certain embodiments, the spacer 60 has first and second sidewalls 63, an outside wall 64, and an inside wall 69. In some cases, the spacer 60 comprises a single body that defines these walls 63, 64, 69. While the spacer 60 may include first and second car portions 167, one or both of them can optionally be omitted. In embodiments where the spacer comprises a single body defining first and second sidewalls 63, an outside wall 64, and an inside wall 69, that single body can optionally be a sheet of metal, such as aluminum or stainless steel. In other cases, it can be a single body of polymer or composite.

In some preferred embodiments of the present group, the spacer 60 bounds an interior space 62 in which desiccant 67 is received. In these embodiments, the spacer's inside wall 69 preferably has a series of apertures 61 that provide gaseous communication between the interior space 62 of the spacer 60 and a between-pane space 50 of the IG unit 40. Moreover, the spacer 60 can optionally include an upstanding mounting rib 168 located between the second sidewall 63 (and/or an aerogel sheet 200) and the series of apertures 61 in the spacer's inside wall 69. As is perhaps best appreciated by referring to FIGS. 18A-20B, the illustrated mounting rib 168 extends along a length (optionally the entire length) of the spacer 60, and likewise the illustrated series of apertures 61 extends along the length of the spacer. Additionally or alternatively, the aerogel seating structure 160 can optionally bound a channel 162 in which an edge region of the aerogel sheet 200 is received, with the channel being located on one side of a mounting rib 168 whereas the series of apertures 61 is located on an opposite side of the mounting rib. As just one example, reference is made to FIG. 21 in view of FIGS. 18A and 18B.

In some cases, a gas gap is located between the aerogel sheet 200 and the first pane. The spacer 60 can optionally bound (e.g., surround or otherwise define) an interior space 62 in which desiccant 67 is received, and the inside wall 69 of the spacer 60 can have a series of apertures 61 extending from the spacer's interior space to the gas gap. This advantageously puts desiccant 67 in the spacer's interior space 62 in gaseous communication with the gas gap. In embodiments of this nature, the IG unit 40 preferably does not include any structure that blocks the gaseous communication provided by the series of apertures 61 in the spacer's inside wall 69.

The multiple-pane insulating glazing unit 40 of any embodiment of the present disclosure can be mounted in a frame 90. In some cases, the spacer 60 and the frame 90 are distinct from each other, such that no part of the frame defines the spacer. This can be appreciated by referring to FIGS. 25 and 31. The multiple-pane insulating glazing unit 40 shown in any of FIGS. 21-24, 28, and 30 can likewise be installed in a frame 90. In such cases, the IG unit 40 is mounted in the frame 90 such that a vision area 95 is located inwardly of the frame, and the seating structure 160 of the spacer 60 preferably is located outside of the vision area.

In another group of embodiments, the invention provides a spacer 60 having a seating structure 160 to support and/or carry an aerogel sheet 200. In this embodiment group, the spacer 60 is configured for use in an aerogel-containing IG unit 40. Preferably, the spacer 60 has an inside wall 69 and opposed first and second sidewalls 63. In some of the present embodiments, the inside wall 69 includes at least one base portion that faces a between-pane space 50 of the IG unit 40 when operatively assembled. The opposed first and second sidewalls 63 preferably are configured to be sealed respectively to first and second panes of the IG unit 40 so as to retain the first and second panes in a substantially parallel spaced-apart arrangement. Thus, the opposed first and second sidewalls 63 of the spacer 60 preferably are sealant beds. In some embodiments of this nature, an entirety of the spacer 60 is configured to be located between (e.g., directly between) the first 100 and second 110 panes of the IG unit 40 when operatively assembled.

The inside wall 69 of the spacer 60 can optionally be configured to be exposed to a between-pane space 50 of the IG unit 40. The seating structure 160 of the present spacer 60 is configured to support and/or carry an aerogel sheet 200 in a seated position within a between-pane space 50 of the IG unit 40 when operatively assembled. Preferably, the seating structure 160 is configured to support and/or carry the aerogel sheet 200 in a seated position alongside a desired one of the first 100 and second 110 panes of the IG unit 40.

In certain embodiments, the seating structure 160 is configured to carry an aerogel sheet 200 in a seated position alongside, yet spaced apart from, the second pane. Three embodiments of this nature are shown in FIGS. 18A-20B.

In some of the present spacer embodiments, an inside wall 69 of the spacer 60 includes at least one base portion that faces (and optionally is exposed to) a between-pane space 50 of the IG unit 40 when operatively assembled. In certain embodiments of this nature, the spacer 60 includes a seating structure 160 (such as an optional mounting rib 168 thereof) that projects inwardly relative to the base portion such that when the IG unit 40 is operatively assembled, the seating structure projects into the between-pane space 50. In some cases, the seating structure 160 projects further into the between-pane space 50 than any other part of the spacer 60. If desired, the spacer's inside wall 69 can include two base portions such that the seating structure 160 is located between them. More will be said of this later.

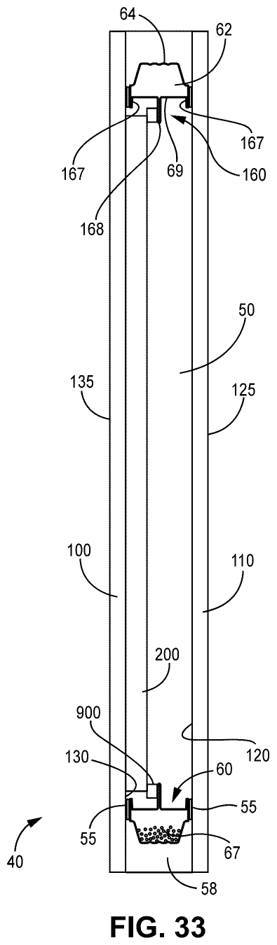

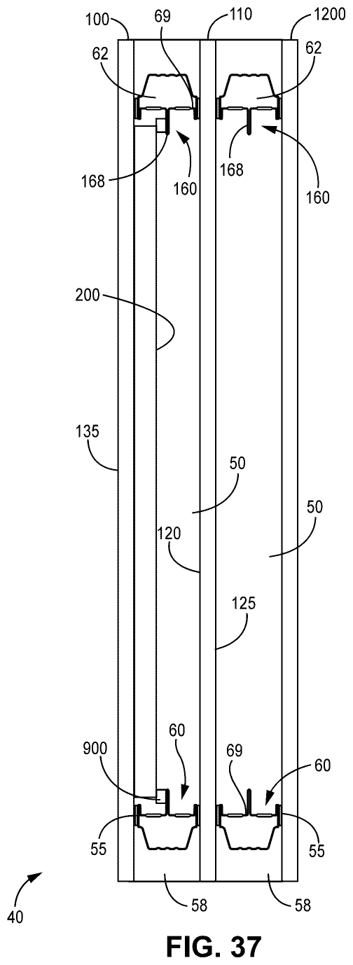

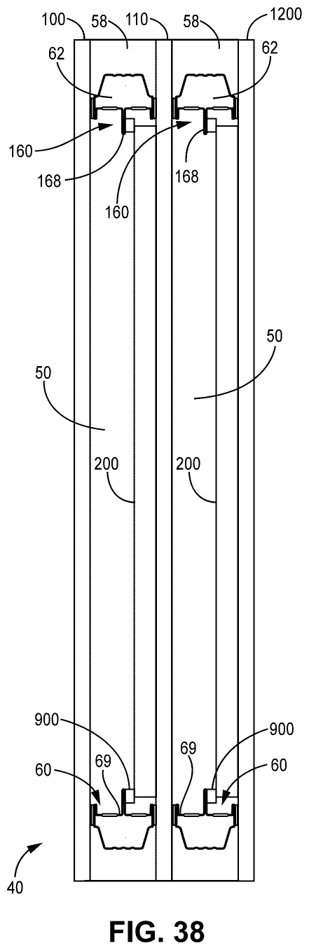

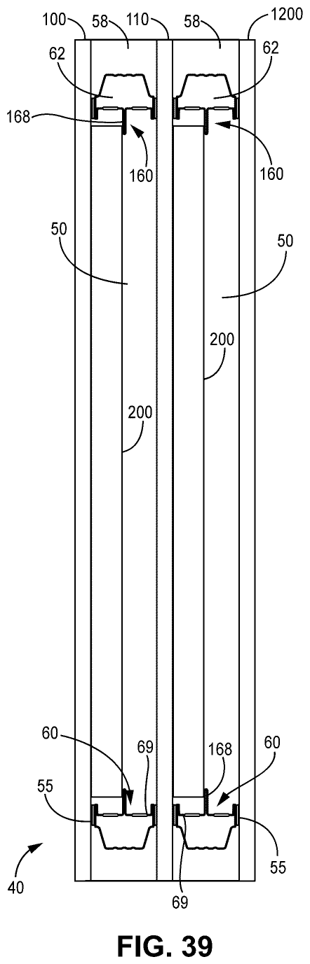

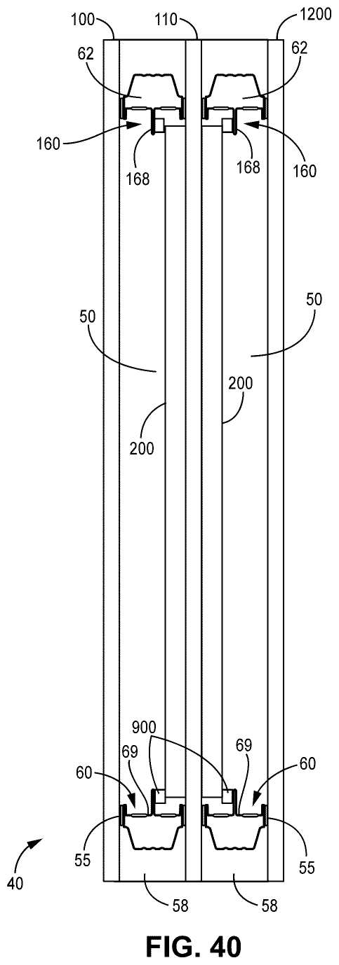

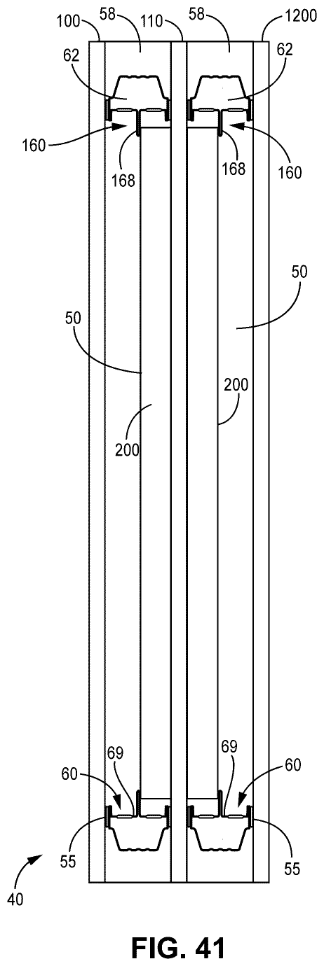

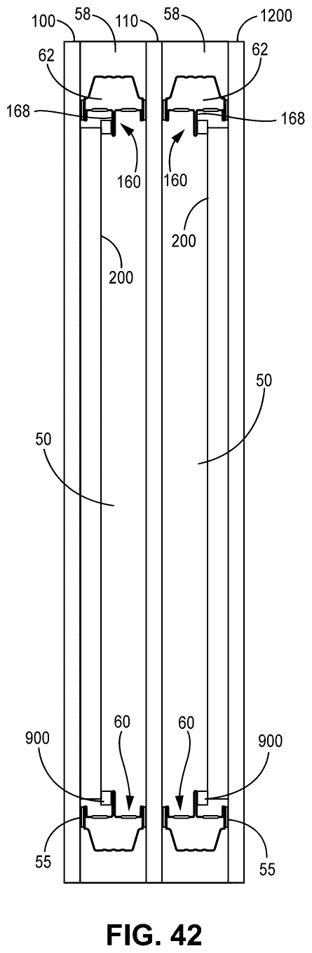

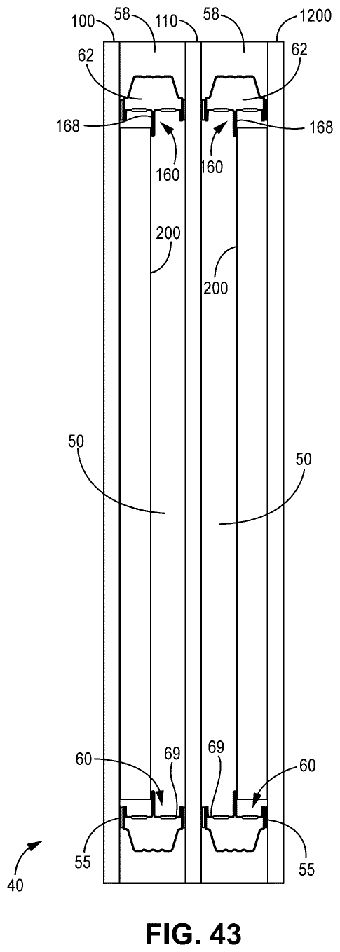

We note in passing that the IG unit 40 can be, for example, a double-pane IG unit or a triple-pane IG unit. Thus, there may be one or two between-pane spaces 50. FIGS. 33-36 show some non-limiting examples of double-pane IG units. FIGS. 37-45 show some non-limiting examples of triple-pane IG units. Moreover, the present spacer can be used advantageously in various embodiments where the IG unit includes more than three panes, if so desired.

In some cases, the spacer 60 is configured to carry the aerogel sheet 200 in the seated position by embracing both first and second faces of the aerogel sheet. This is the case in the embodiments of FIGS. 18A-20B. In other cases, the spacer 60 is configured to support the aerogel sheet 200 in the seated position by supporting only one of the two faces of the aerogel sheet. Reference is made to the non-limiting examples of FIGS. 27A-27B, 32, and 46-48. It is to be appreciated that such spacer embodiments, if desired, can be used such that the spacer also supports the perimeter edge of the aerogel sheet. This can be appreciated by referring to the non-limiting example of FIG. 28.

In certain embodiments of the present group, a single body defines the seating structure 160 of the spacer 60. For example, a single body defining part (or all) of the spacer 60 can optionally define the entire seating structure 160. If desired, the spacer 60 (or at least an inside wall 69 thereof) can be a single body, e.g., a single body of metal (e.g., a sheet of metal), polymer (e.g., foam), or composite.

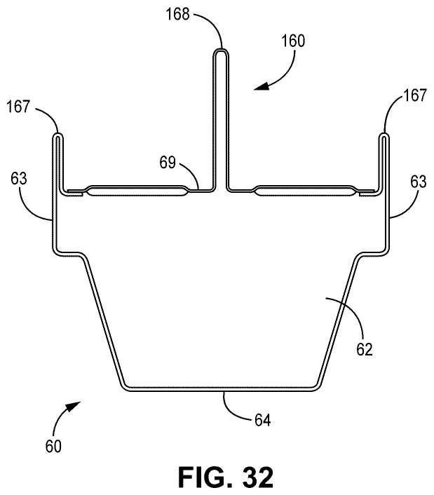

Preferably, the spacer's seating structure 160 is defined, at least in part, by an inside wall 69 of the spacer 60. In the embodiments shown in FIGS. 18A-20B, for example, the seating structure 160 is defined, entirely, by the inside wall 69 of the spacer 60. This is also the case in the embodiments of FIGS. 32 and 46-48. However, is not required.

In some cases, the inside wall 69 of the spacer 60 (or the entire spacer) is formed of metal, such as aluminum, stainless steel, or Hi-Q steel. In such cases, the spacer can be formed by roll forming. Suitable spacer roll forming services can be obtained commercially from Allmetal, Inc. (Itasca, Illinois, U.S.A.). In other cases, polymer or composite is used. In such cases, the spacer can optionally be formed by extrusion.

With respect to the configuration of the spacer's seating structure 160, it preferably: (i) bounds a mounting channel 162 or another mounting seat, (ii) includes an upstanding rib 168 or a mounting shoulder, or (iii) both (i) and (ii).

In some of the present embodiments, the seating structure 160 of the spacer 60 bounds a mounting channel 162 configured to receive an edge region of the aerogel sheet 200 when the aerogel sheet is in the seated position. Various different spacer 60 configurations can be used to provide such a channel 162, including the non-limiting configurations shown in FIGS. 18A-20B.

With continued reference to FIGS. 18A-20B, the illustrated spacer 60 includes first and second ear portions 167, which are respectively defined, at least in part, by interior regions of the spacer's first and second sidewalls 63. The illustrated second ear portion bounds a side of the channel 162. As shown in certain other drawings of this disclosure, various spacer embodiments of the present disclosure may include such ear portions 167. It is to be appreciated, however, that these details are by no means limiting. If desired, one or both ear portions 167 can be omitted. Reference is made to the non-limiting examples of FIGS. 27A-27B, 47, and 48.

In some embodiments of the present group, the spacer 60 includes an upstanding mounting rib 168. Four examples of such a mounting rib 168 are shown in FIGS. 18A-20B and 27A-27B. In three of these examples (see FIGS. 18A-20B), the mounting rib 168 bounds a side of the illustrated channel 162. In these examples, the illustrated channel 162 is bounded on one side by the mounting rib 168 while being bounded on the other side by an ear portion 167 of the spacer. In other embodiments, one or both car portions 167 of the spacer 60 are omitted and there is an L-shaped mounting seat (e.g., a laterally open L-shaped mounting seat) along one side of the mounting rib 168. Reference is made to the non-limiting example of FIGS. 27A-27B. FIGS. 32 and 46-48 show still other embodiments wherein the spacer 60 includes an upstanding mounting rib 168. More generally, the spacer can have different seating structures of various configurations.

In certain embodiments involving a mounting rib 168, it has a height equal to or shorter than the height(s) of one or two optional car portions 167 of the spacer 60. Reference is made to FIGS. 20A-20B, 24, 27A-27B, and 28. In other cases, the illustrated ear portion(s) 167 are omitted.

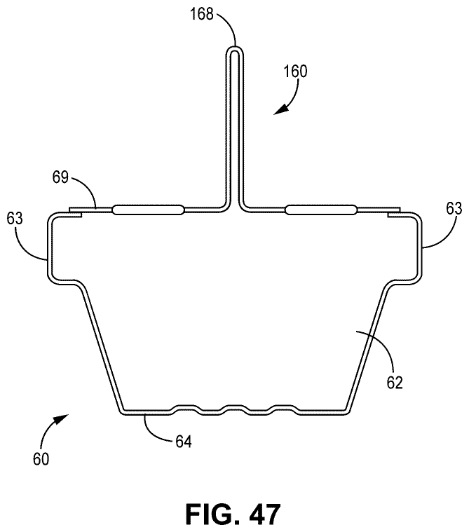

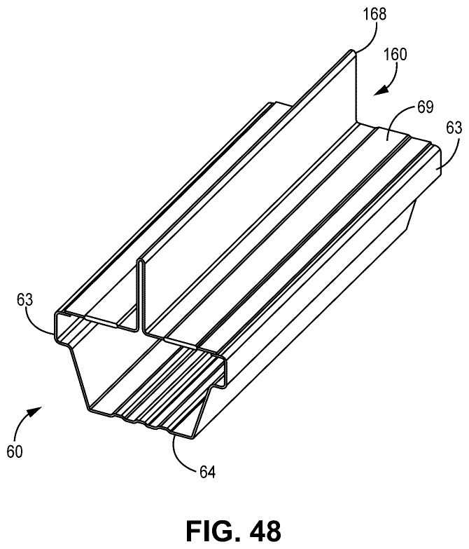

In other embodiments involving a mounting rib 168, it has a height greater than the height(s) of one or two optional car portions 167 of the spacer 60. Reference is made to FIGS. 18A-19B, 21-23, 32, and 46. Here too, one or both of the illustrated car portions 167 can optionally be omitted (see, e.g., FIGS. 47 and 48).

Some embodiments involving a mounting rib 168 configure it with an aspect ratio of greater than 5, or even greater than 8. A few non-limiting examples are shown in FIGS. 32 and 46-48. The aspect ratio here is defined as the height of the mounting rib 168 divided by the width of the mounting rib. It is to be appreciated, however, that a mounting rib can be provided with various different configurations, e.g., it may have an aspect ratio outside these ranges.

In the spacer embodiments of FIGS. 32 and 46-48, the illustrated mounting rib 168 is located at a center point (i.e., halfway) along the width of the spacer 60. This can provide advantages in terms of manufacturing and performance; it can also facilitate a range of different options for arranging one or more aerogel sheets 200 in the IG unit 40 (see FIGS. 33-45). If desired, however, any one of these illustrated mounting ribs 168 can be reconfigured to be closer to one side of the spacer and further from the other side of the spacer.

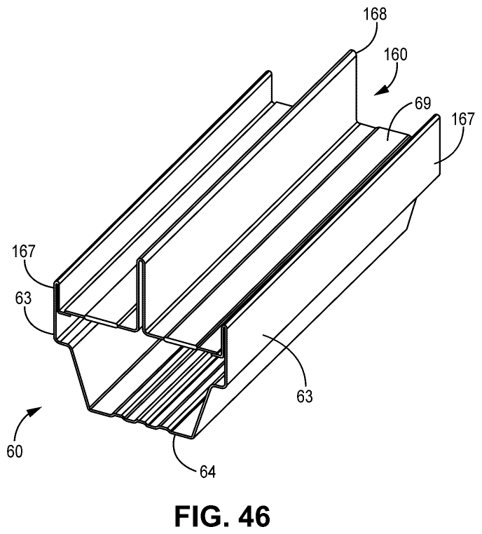

With continued reference to FIGS. 32 and 46-48, several examples are shown where an inside wall 69 of the spacer 60 includes two base portions. Here, a mounting rib 168 is located between the two base portions. As shown in FIG. 32, the two base portions can optionally each include corrugations. In other cases, the two base portions are not corrugated (see FIGS. 46-48). In FIG. 32, a single strip of metal preferably defines the illustrated mounting rib 168 and each of the two base portions. In such cases, the spacer preferably includes a metal channel member that is joined to the noted single strip of metal. Moreover, the single strip of metal can be joined to the channel member, by a plurality of welds, so as to create therebetween a plurality of openings that provide gaseous communication between a hollow interior 62 of the spacer 60 and the between-pane space 50. In FIG. 32, the plurality of welds is located further from the mounting rib 168 than are the corrugations. The hollow interior 62 of the illustrated spacer 60 is configured to receive desiccant, such as a particulate desiccant. The details described in this paragraph, however, are by no means limiting.

Thus, in FIG. 32, the illustrated spacer 60 bounds two series of apertures, and the seating structure 160 is located between the two series of apertures. This can also be the case for various other spacer shapes and configurations. In more detail, the illustrated seating structure 160 here comprises an upstanding mounting rib 168 that extends along the length (optionally the entire length) of the spacer, and the two series of apertures likewise extend along the length (optionally the entire length) of the spacer. Here again, the details described in this paragraph are not limiting.

When provided, the mounting rib 168 can optionally be formed of metal. In some embodiments, for example, the inside wall 69 of the spacer 60 is formed of metal, and the mounting rib 168 is an integral projection of the metal inside wall. It is to be appreciated, however, that the mounting rib can alternatively be polymer or composite. For example, the channel portion and the inside wall of the spacer design in FIGS. 47 and 48 can optionally be formed by extrusion.

In other embodiments, rather than having a mounting rib, the spacer can have a mounting shoulder that bounds a seat (e.g., an L-shaped seat) for an aerogel sheet. Various spacer configurations can be used to provide such a mounting shoulder. In some cases, the spacer has a channel bounded by both a mounting shoulder and an car portion of the spacer. One non-limiting example is shown in FIGS. 29A-29B and 30. In other cases, a spacer like that shown in FIG. 29B can have the ear 167 shown on the left side of this figure omitted, such that the illustrated mounting shoulder bounds a laterally open seat (e.g., a laterally open, L-shaped seat) for an aerogel sheet.

Thus, one subgroup of spacer embodiments involves a mounting shoulder that bounds a laterally open seat. In a further example, a central ridge (e.g., that is part of an inside wall of the spacer) defines two mounting shoulders on its opposite sides, and these two shoulders bound two laterally open seats, one at each side of the spacer. Given the present teaching as a guide, various other spacer designs will be apparent to a person of ordinary skill in this field.

Some embodiments of the present group involve a channel 162 having a base 162B. When provided, the base 162B of such a channel can be defined by a portion of the spacer's inside wall 69. In FIGS. 19A-19B, 20A-20B, and 29A-29B, the portion of the inside wall 69 that defines the base 162B is closer to the spacer's outside wall 64 than is the rest of the inside wall 69. As noted above, this is referred to herein as a recessed channel.

In certain embodiments, the spacer 60 has first and second sidewalls 63, an outside wall 64, and an inside wall 69. In some cases, the spacer 60 comprises a single body that defines these walls 63, 64, 69. In embodiments where the spacer comprises a single body defining first and second sidewalls 63, an outside wall 64, and an inside wall 69, that single body can optionally be a sheet of metal, such as aluminum or stainless steel. In other cases, the spacer can comprise one or more bodies of polymer or composite. As noted above, the spacer in FIGS. 47 and 48 can optionally comprise extruded polymer.

In some embodiments, a first body defines an inside wall 69 of the spacer, while a second body defines first and second sidewalls 63 and an outside wall 64. While some of the illustrated spacers 60 include two car portions 167, one or both of them can optionally be omitted. In such cases, the first body can optionally be a single sheet of metal, and the second body can optionally be a metal channel member. Suitable metal options include aluminum, stainless steel, or Hi-Q steel. In other cases, an inside wall (or inside wall portion) and a channel member (or channel portion) comprise polymer or composite.

In some preferred embodiments of the present group, the spacer 60 bounds an interior space 62 configured to receive (or containing) desiccant 67. In some cases, at least initially, the interior space 62 of the spacer 60 is empty other than containing gas. Thus, certain embodiments provide a spacer 60 of the nature described herein where it bounds a hollow interior space 62 that is empty other than containing gas. In such cases, the spacer's interior can advantageously be filled with at least some desiccant, such as particulate desiccant, before assembling the spacer together with two or more panes and at least one aerogel sheet.

In certain embodiments, the spacer's inside wall 69 has and/or bounds a series of apertures 61 configured to provide (or providing) gaseous communication between an interior space 62 of the spacer 60 and a between-pane space 50 of the aerogel-containing IG unit 40. In some cases, the spacer 60 includes an upstanding mounting rib 168 located between a sidewall 63 and a series of apertures 61 in the spacer's inside wall 69. As can be appreciated by referring to FIGS. 18A-20B, the illustrated mounting rib 168 extends along a length (optionally the entire length) of the spacer 60, and likewise the illustrated series of apertures 61 extends along the length of the spacer. In some cases, the seating structure 160 bounds a channel 162 configured to receive an edge region of the aerogel sheet 200, with the channel being located on one side of a mounting rib 168 whereas the series of apertures 61 is located on an opposite side of the mounting rib. As one example, reference is made to FIGS. 18A-18B. In other cases, the seating structure 160 bounds a channel 162 configured to receive an edge region of the aerogel sheet 200, with the channel being located on one side of a mounting shoulder whereas the series of apertures 61 is located on an opposite side of the mounting shoulder. Reference is made to FIGS. 29A-29B.

In some of the spacer embodiments, an optional gasket 900 is provided on the seating structure 160 of the spacer 60. Reference is made to FIGS. 33, 35, 37, 38, 40, 42, and 44. When provided, the gasket 900 can optionally be adhered to the seating structure 160 of the spacer 60. In certain embodiments, the gasket 900 comprises one or more pieces of foam.

Furthermore, any spacer embodiment of the present disclosure can optionally be configured such that it does not have two L-shaped glazing seats on opposite sides of the spacer for receiving first and second panes.

Any IG unit embodiment of the present disclosure can optionally include a low-emissivity coating, such as on the #2 surface or on the #3 surface. In FIGS. 21-24 and 33-45, for example, a low-emissivity coating can optionally be added on the interior surface of pane 100. Additionally or alternatively a low-emissivity coating can optionally be added on the interior surface of pane 110. In FIG. 25, a low-emissivity coating can advantageously be added on surface 130. In FIG. 31, an optional low-emissivity coating 770 is shown on the interior surface of pane 100.

One or more low-emissivity coatings can optionally be added on any one or more interior surfaces of a triple-pane glazing unit. FIGS. 37-45 show various examples of such a glazing unit. Here, an optional low-emissivity coating can be added to the interior surface of pane 100. Additionally or alternatively, an optional low-emissivity coating can be added to surface 125. In other cases, an optional low-emissivity coating is added to surface 120. Another option is to provide such coatings on both the interior surface of the first pane 100 and the interior surface of the third pane 1200. Still another option is to provide such coatings on both surfaces 120, 125 of the second pane 110. Given the present teaching as a guide, further variants of this nature will be apparent to a person of ordinary skill in this field.

When provided, the low-emissivity coating preferably includes at least one silver-inclusive film, which desirably contains more than 50% silver by weight (e.g., a metallic silver film). In some cases, the optional low-emissivity coating includes three or more infrared-reflective films (e.g., silver-containing films). Low-emissivity coatings having three or more infrared-reflective films are described in U.S. Patent and Publication Nos. US2007-0082124 and 7,572,511 and 7,572,510 and 7,572,509 and 11/545,211 and 7,342,716 and 7,339,728, the teachings of each of which are incorporated herein by reference. In some cases, the optional low-emissivity coating includes four silver layers. In other cases, the optional low-emissivity coating is a “single silver” or “double silver” low-emissivity coating, which are well-known to skilled artisans. Various low-emissivity coatings are commercially available from Cardinal CG Company (Eden Prairie, Minnesota, U.S.A.).

Furthermore, any IG unit embodiment of this disclosure can optionally include a transparent conductive oxide coating, e.g., on an exterior surface of either the outboard pane or the inboard pane. In some cases, an aerogel sheet and a transparent conductive oxide coating are both supported by the same pane, e.g., by being on opposite surfaces of such pane. This pane, for example, may be an inboard pane. In other cases, it is an outboard pane. A transparent conductive oxide coating (e.g., on one or both exterior surfaces of an IG unit) can optionally be provided in any embodiment of the present disclosure.

When provided, the transparent conductive oxide coating may comprise, consist essentially of, or consist of indium tin oxide (“ITO”). In alternate embodiments, zinc aluminum oxide, SnO:Sb, sputtered SnO:F, or another known TCO is used. Thus, in certain embodiments, the optional transparent conductive oxide coating includes a sputtered film that includes tin (e.g., comprising tin oxide together with antimony, fluorine, or another dopant). In other embodiments, the optional transparent conductive oxide coating includes a pyrolytic film that includes tin (e.g., comprising tin oxide together with antimony, fluorine, or another dopant). In some cases, the TCO film (which either forms or is part of the optional transparent conductive oxide coating) includes carbon nanotubes. Preferably, the TCO film (which optionally comprises ITO) is provided at a thickness of 10,000 Å or less, such as between about 1,000 Å and about 7,000 Å, e.g., from 1,000 Å to 1,750 Å, such as about 1,300-1,600 Å. For any embodiment where the transparent conductive oxide coating is provided, it can optionally comprise a TCO (e.g., ITO) film having a thickness of from 1,000 Å to 1,750 Å.

When provided, the transparent conductive oxide coating can, for example, be a coating of the type described in any of U.S. Pat. Nos. 9,862,640 or 10,000,965 or 10,000,411 or 11,155,493, the teachings of each of which concerning the transparent conductive oxide coating are incorporated herein by reference.

Thus, in some cases, the IG unit includes both a transparent conductive oxide coating and a low-emissivity coating. This, however, is not required. For example, the IG unit can include the low-emissivity coating while being devoid of the transparent conductive oxide coating.

In some embodiments, pane 100 is an outboard pane that defines both a #1 surface (i.e., surface 135) and a #2 surface (i.e., surface 130), and pane 110 is an inboard pane that defines both a #3 surface (i.e., surface 120) and a #4 surface (i.e., surface 125). As noted above, the IG unit 40 can optionally be mounted in a frame 90. Reference is made to the non-limiting example of FIG. 25. Here, the #1 surface is exposed to an outdoor environment, while the #4 surface preferably is exposed to an indoor environment. The frame 90 can be any type of window frame or other glazing frame; the frame can be a sash.

Various embodiments of the invention involve an aerogel sheet carried directly against (e.g., so as to contact) a pane of an IG unit. In such cases, whether the aerogel sheet is supported and/or carried by a seating structure of the spacer itself or by an aerogel sheet holder separate from the spacer, there can optionally be no adhesive (e.g., no optical adhesive) between the aerogel sheet and the noted pane. Due to support from the spacer or aerogel sheet holder, it may be unnecessary to provide such an adhesive. In other cases, though, there may also be adhesive or other bonding (e.g., Van der Waals bonding) securing the aerogel sheet to the pane. This can optionally be the case in various embodiments of this disclosure.

The present disclosure provides various embodiments of a multiple-pane insulating glazing unit 40 that includes an aerogel sheet 200. As noted above, the IG unit 40 includes first 100 and second 110 panes, a spacer 60, and the aerogel sheet 200. Preferably, the spacer 60 maintains the first 100 and second 110 panes in a substantially parallel spaced-apart arrangement with a between-pane space 50 located between the first and second panes. In one group of IG unit embodiments, the spacer 60 has a seating structure 160 that facilitates retaining the aerogel sheet 200 in a seated position within the between-pane space 50. FIGS. 33-36 show various examples of a double-pane IG unit 40 of this nature. FIGS. 37-45 show various examples of a triple-pane IG unit 40 of this nature.

In the present embodiment group, the seated position of the aerogel sheet 200 preferably is characterized by a first face of the aerogel sheet 200 being carried alongside a desired one of the first 100 and second 110 panes. As discussed previously, the aerogel sheet 200 has opposed first and second faces and a perimeter edge. In the non-limiting example of FIG. 33, the first face of the aerogel sheet 200 is carried alongside an interior surface 130 of the first pane 100.

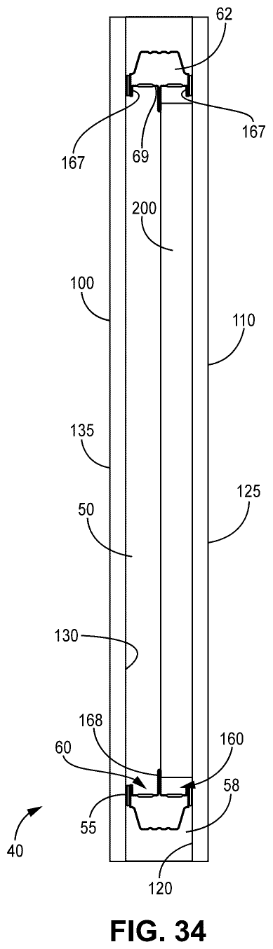

It is to be appreciated, however, that the aerogel sheet can alternatively be carried alongside the second pane. In FIG. 34, for example, the first face of the aerogel sheet 200 is carried alongside an interior surface 120 of the second pane 110.

Moreover, no specific orientation or position is required by describing a given pane as the “first pane.” The first pane may be exposed to an outdoor environment when the IG unit is ultimately installed (e.g., in a wall of a building). In other cases, however, the first pane is exposed to an indoor (e.g., room-side) environment of a building when the IG unit is ultimately installed.

In some embodiments of the present group, the seated position of the aerogel sheet 200 is characterized by the first face of the aerogel sheet being in contact with the desired one of the first 100 and second 110 panes. In FIG. 33, for example, the first face of the aerogel sheet 200 is shown in contact with the interior surface 130 of the first pane 100. Although not shown in FIG. 33, there can optionally be a low-emissivity coating (or another coating or layer) between the first pane 100 and the aerogel sheet 200. Similarly, in FIG. 34, the first face of the aerogel sheet 200 is shown in contact with the interior surface 120 of the second pane 110. In such cases, there can optionally be a low-emissivity coating (or another coating or layer) between the second pane 110 and the aerogel sheet 200. Suitable low-emissivity coatings are described above.

Preferably, there is a gas gap alongside the second face of the aerogel sheet 200. One example is shown in FIG. 33. Another example is shown in FIG. 34. In some cases, the width of the gas gap is greater than half the width of the spacer 60. This too is shown in the non-limiting examples of FIGS. 33 and 34. More generally, the width of the gas gap, when provided, can be greater or lesser, and can generally be in any range desired to accommodate various IG unit designs and dimensions.

In the present embodiment group, the aerogel sheet 200 preferably is sandwiched between the seating structure 160 of the spacer 60 and the desired one of the first 100 and second 110 panes, e.g., such that the seating structure of the spacer thereby supports the second face of the aerogel sheet. In addition, the aerogel sheet 200 preferably has a major dimension (e.g., a length) that is smaller than a corresponding major dimension (e.g., a length) of the desired one of the first 100 and second 110 panes, such that the perimeter edge of the aerogel sheet is set back inwardly from a perimeter edge of the desired one of the first and second panes. This can be seen, for example, in FIGS. 33 and 34. Furthermore, in some embodiments of this nature, there is no contact between the spacer 60 and the perimeter edge of the aerogel sheet 200.

In the present embodiment group, an entirety of the spacer 60 can optionally be located between (e.g., directly between) the first 100 and second 110 panes. This is the case for the IG unit 40 of FIG. 33, and the IG unit 40 of FIG. 34. Furthermore, the spacer 60 preferably has opposed first and second sidewalls 63, which are sealed respectively to the first 100 and second 110 panes.

As noted above, the first 100 and second 110 panes respectively have first and second perimeter edges. In some of the present embodiments, no part of the spacer 60 overlies the first perimeter edge, and no part of the spacer overlies the second perimeter edge. This can be seen, for example, in FIGS. 33-45. Constructions of this nature can provide advantages in terms of unit profile and performance, manufacturing quality and ease, and advantageous incorporation into window frames, sashes, and the like.

This, however, is not required. For example, some alternative triple-pane IG unit embodiments can involve a single spacer bridging all three panes. In such embodiments, the spacer may overlie the perimeter edges of one or more of the panes. Moreover, some alternative double-pane IG unit embodiments can involve a spacer that overlies the perimeter edges of one or both panes.

Part of the IG unit is a sealant system located at a perimeter edge region of the unit. The sealant system preferably seals the spacer to both the first and second panes. As noted above, the sealant system includes one or more deposits of sealant. In some embodiments, no part of the sealant system overlies the first perimeter edge, and no part of the sealant system overlies the second perimeter edge. But this is not required. For example, a skim coat of silicone or the like may be provided as the illustrated sealant deposit 58, which is shown as secondary sealant. In such cases, part of the skim coat may overlie the perimeter edge of the first pane, the second pane, or both.

In a preferred sealant system, first and second sealant beads 55 respectively seal the first 100 and second 110 panes to the spacer 60, and the sealant system further includes a sealant deposit 58 over an outside wall 64 of the spacer. As discussed previously, embodiments of this nature tend to involve the first and second sealant beads 55 being primary sealant (e.g., PIB), while the sealant deposit 58 is secondary sealant (e.g., silicone). Reference is made to the previous discussions herein about sealant options. The first and second sealant beads 55 preferably are each located entirely between (e.g., directly between) the first 100 and second 110 panes, and when provided the sealant deposit 58 can optionally also be located entirely between (e.g., directly between) the first 100 and second 110 panes.

In some embodiments of the present group, the perimeter edge of the aerogel sheet 200 does not contact the spacer 60, but rather is spaced apart inwardly from the spacer. Furthermore, in some cases, the aerogel sheet 200 does not contact the sealant system, but rather is spaced apart inwardly from the sealant system.

As noted above, in the present embodiment group, the aerogel sheet 200 preferably is sandwiched between the seating structure 160 of the spacer 60 and a desired one of the first 100 and second 110 panes. In some cases, there is no adhesive between the aerogel sheet 200 and the seating structure 160 of the spacer 60. This may be advantageous to ensure there is no adverse result from adhesive contacting the aerogel. In other cases, however, it may be desirable to provide adhesive therebetween, e.g., to provide additional retention means for the aerogel. Additionally or alternatively, there may be embodiments where the aerogel sheet contacts a bead of sealant on a sidewall of the spacer (e.g., for additional retention).

The aerogel sheet 200 has opposed first and second faces. Preferably, the first face of the aerogel sheet 200 is carried against the desired one of the first 100 and second 110 panes, while the second face of the aerogel sheet is carried against the seating structure 160 of the spacer 60. In some cases, the spacer 60 supports the aerogel sheet 200 only at the second face of the aerogel sheet. This is shown, for example, in FIGS. 33 and 34.

The present IG unit embodiments can optionally include a gasket 900 between the aerogel sheet 200 and the seating structure 160 of the spacer 60. When provided, the gasket 900 preferably is softer and/or more compressible than the aerogel sheet 200.

Thus, in some embodiments involving a gasket 900, it comprises a material that is softer than the aerogel sheet 200. In other words, the gasket 900 can comprise a material having a hardness that is lower than a hardness of the aerogel sheet 200. In certain cases, the hardness of the gasket material is at least 5%, at least 10%, at least 15% or perhaps at least 20% lower than the hardness of the aerogel. In some cases, the material of the gasket 900 has a hardness of less than 10 MPa. These details, however, are by no means required.

Hardness can be determined using any suitable technique and mechanism. If desired, the hardness can be measured by obtaining microindentation measurements for a material and then calculating a hardness value from those measurements. For example, the hardness measure can be obtained using a method described in M. Moner-Girona et al. Journal of Non-Crystalline Solids 285 (2001) 244-250, the contents of which are incorporated herein by reference.

Additionally or alternatively, the gasket 900, when provided, can optionally comprise a material having a compression modulus that is lower than a compression modulus of the aerogel sheet 200. In certain cases, the compression modulus of the gasket material is at least 5%, at least 10%, at least 15% or at least 20% lower than the compression modulus of the aerogel sheet. The compression modulus measure can be determined using any suitable technique and mechanism. For example, the compression modulus can be reported as a Young's Modulus for compression. In some cases, the Young's Modulus for compression of the gasket material is less than 10 MPa. It is to be appreciated, however, that these details are not required.

Young's Modulus for compression can be measured by obtaining microindentation measurements for a material and then calculating a Young's Modulus from those measurements. The Young's Modulus can be obtained using a method described in M. Moner-Girona et al. Journal of Non-Crystalline Solids 285 (2001) 244-250.

In some embodiments involving a gasket 900, it comprises one or more pieces of foam. In such cases, there preferably is no adhesive between the aerogel sheet and the one or more pieces of foam. Furthermore, the foam preferably has a composition that does not outgas into the IG unit, at least not substantially, since it is desirable to avoid outgassing that may adversely impact the integrity of the IG unit.

When the gasket 900 comprises foam, it can advantageously be a closed-cell foam, e.g., comprising silicone or polyurethane. The density of a suitable foam may range, for example, from 15 lb/ft³ to 80 lb/ft³. One suitable example is St. Gobain R10404 silicone foam, which is a closed-cell silicone foam having a density of 50-80 lb/ft³, such as about 69 lb/ft³.

In some embodiments of the present group, the seating structure 160 of the spacer 60 comprises a mounting rib 168. In previous sections of this disclosure, a number of different spacer designs are disclosed wherein the spacer 60 has a seating structure 160 comprising a mounting rib 168. FIGS. 32 and 46-48 show four additional examples. Here, the mounting rib 168 is located at a center point (i.e., halfway) along a width of the spacer 60. It is to be appreciated, however, that this is not required.

As discussed previously, the spacer 60 preferably includes an inside wall 69 having at least one base portion, which faces the between-pane space 50. In various embodiments, the inside wall 69 has two base portions located on opposite sides of a mounting rib 168. Several non-limiting examples are shown in FIGS. 32 and 46-48.

In some embodiments where the seating structure 160 of the spacer 60 comprises a mounting rib 168, the mounting rib has an aspect ratio of greater than 5, or even greater than 8. This is shown, for example, in FIGS. 32 and 46-48. The aspect ratio here is defined as the height of the mounting rib 168 divided by the width of the mounting rib.

In some embodiments, the spacer 60 includes an inside wall 69 having two base portions located on opposite sides of a mounting rib 168, and each of the two base portions includes corrugations. This is shown, for example, in FIGS. 32-45. These features, however, are merely optional; they are by no means required.

In FIGS. 33 and 34, the illustrated aerogel sheet 200 has a perimeter edge that is adjacent to, but spaced apart inwardly from, a desired one of the two base portions of the spacer's inside wall 69. Preferably, this is the case about an entirety of the IG unit 40.

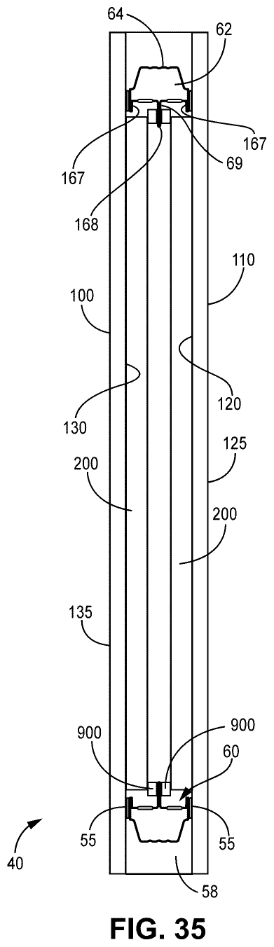

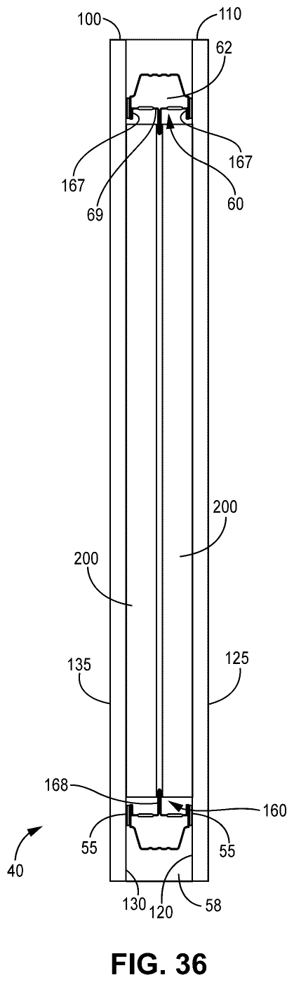

In certain embodiments of the present group, the spacer 60 has a width, the aerogel sheet 200 has a thickness, the aerogel sheet is surrounded by the spacer, and the thickness of the aerogel sheet is less than 50% of the width of the spacer. In addition, the thickness of the aerogel sheet 200 can optionally be greater than 16% of the width of the spacer 60. One example is shown in FIG. 33. Another example is shown in FIG. 34. Two more examples are shown in FIGS. 35 and 36, which show embodiments where each IG unit 40 includes two aerogel sheets 200. These relative thickness details, however, are certainly not required.

In the spacer design of FIG. 32, the inside wall 69 of the spacer 60 can optionally be formed by a single strip of metal, such that the single strip of metal defines the illustrated mounting rib 168 and each of the two base portions of the spacer's inside wall 69. Furthermore, such a spacer can optionally include a metal channel member, which is joined, by a plurality of welds, to the single strip of metal that defines the illustrated mounting rib 169 and each of the two base portions of the spacer's inside wall 69. In such cases, a plurality of openings adjacent the plurality of welds provides gaseous communication between a hollow interior 62 of the spacer 60 and a between-pane space 50 of the IG unit 40. In FIG. 32, each of the two base portions of the spacer's inside wall 69 includes corrugations, and the plurality of welds (and the plurality of openings) is located further from the mounting rib 168 than are the corrugations. These details, however, are merely optional.

Thus, in some embodiments of the present group, the spacer 60 has a hollow interior space 62 that is empty other than containing gas and some particulate desiccant 67.

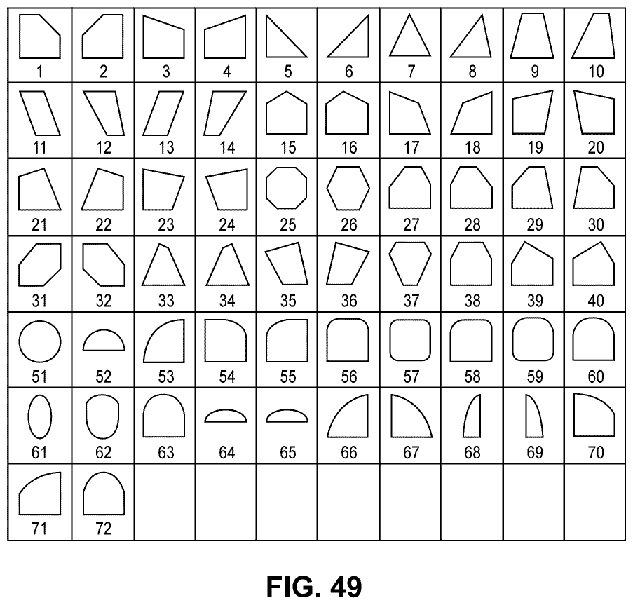

The panes and the IG unit can be provided in many different shapes. Reference is made to FIG. 49, which shows seventy-two different shape options. In many cases, each pane (and the IG unit) will have a shape that is rectangular.

In some embodiments of the present group, the first 100 and second 110 panes each have a rectangular configuration, the aerogel sheet 200 has a configuration that is at least generally rectangular, and a gas gap is located along one side of the aerogel sheet. In embodiments of this nature, the aerogel sheet 200 preferably has a width and a length that are smaller than a width and a length of the first 100 and second 110 panes. In such embodiments, an entirety of the spacer 60 can optionally be located between (e.g., directly between) the first 100 and second 110 panes. This is shown, for example, in FIGS. 33-36. In addition, the aerogel sheet 200 preferably is surrounded by the spacer 60. As noted above, the aerogel sheet 200 has a perimeter edge and opposed first and second faces. Preferably, the seating structure 160 of the spacer 60 supports the second face of the aerogel sheet 200, such that the aerogel sheet is sandwiched between the seating structure of the spacer and a desired one of the first 100 and second 110 panes.

In some embodiments of the present group, the spacer 60 includes an inside wall 69 comprising at least one base portion that faces (and optionally is exposed to) a between-pane space 50 of the IG unit 40. In certain embodiments of this nature, the seating structure 160 of the spacer 60 projects inwardly relative to the base portion of the spacer's inside wall 69 to support the second face of the aerogel sheet 200. Furthermore, in some cases, the spacer 60 supports the aerogel sheet 200 only at the second face of the aerogel sheet.

Certain embodiments of the invention provide a method of manufacturing a multiple-pane insulating glazing unit 40. In one group of these embodiments, the method includes: (i) providing an aerogel sheet 200 on a surface 130 of a pane 100, and (ii) adhering a spacer 60 onto a perimeter of the pane 100 such that the aerogel sheet 200 is sandwiched between the pane 100 and a seating structure 160 of the spacer.

In some embodiments of the present group, the aerogel sheet 200 is provided on the surface 130 of the pane 100 by handling the aerogel sheet and placing it on the surface of the pane. The aerogel sheet may be handled manually (e.g., by one or more workers holding it carefully), by using an automated handling system (e.g., using one or more automated grippers), or by a combination of both. Thus, in some cases, the aerogel sheet 200 is provided on the surface 130 of the pane 100 by moving the aerogel sheet (optionally in a downward direction) toward the surface of the pane and placing the aerogel sheet on the surface of the pane.

In more detail, the aerogel sheet 200 can be placed on the surface 130 of the pane 100 and, optionally, pressed forcibly against the surface of the pane. In some cases, the aerogel sheet is placed in contact with the surface of the pane, and the aerogel sheet adheres to the surface of the pane through van der Waals bonding. In other cases, the aerogel sheet is placed in contact with a surface of the pane, and the aerogel sheet is adhered to the surface of the pane by an adhesive (e.g., an optical adhesive).

Thus, the present method can optionally include bonding the aerogel sheet to the surface of the pane, pressing the aerogel sheet forcibly against the surface of the pane, or both. The optional step of pressing the aerogel sheet forcibly against the surface of the pane can be done using a desired pressure, such as a pressure in the range of 0.1 kPa to 100 kPa.

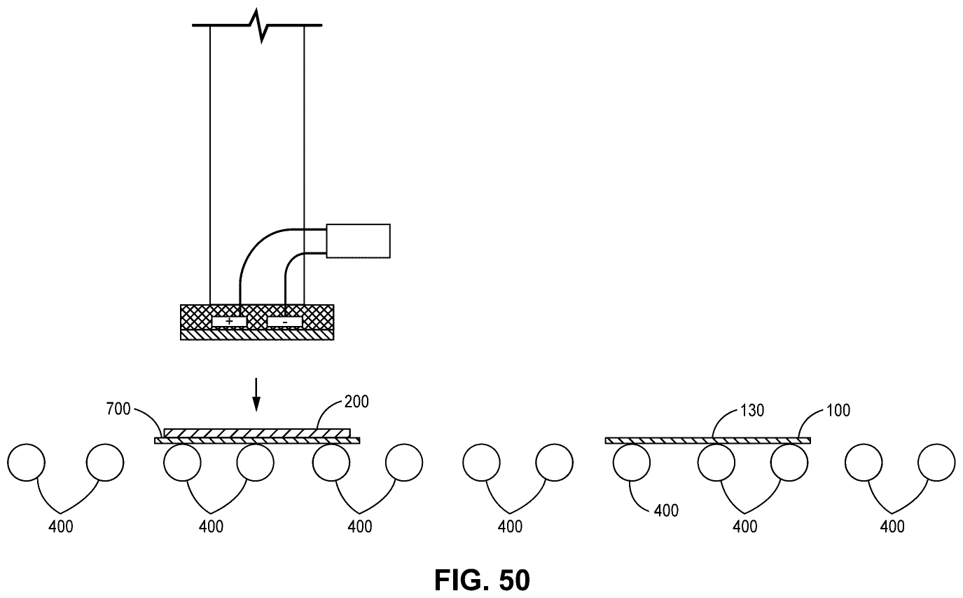

The handling can optionally include an operation in which the aerogel sheet 200, the pane 100, or both are maintained in a horizontal (or at least generally or substantially horizontal) position. For example, the aerogel sheet may initially be resting in a horizontal position on a support substrate, such as a drying substrate (which may have been used in a prior drying operation). Various support substrates can be used, depending upon preceding processes. Reference is made to FIG. 50. Here, the aerogel sheet 200 is resting in a horizontal position on a support substrate 700. One or more grippers can optionally be used to lift the aerogel sheet 200 off the support substrate 700, and then either: (i) a pane 100 is moved under the aerogel sheet, or (ii) the gripper(s) are used to move the aerogel sheet to a position over a pane staged nearby. Either way, the aerogel sheet 200 can then be lowered onto the pane 100 (which, at the time, may be in a horizontal position). This may advantageously bond the aerogel sheet 200 to the surface 130 of the pane 100 (e.g., due to Van der Waals bonding).

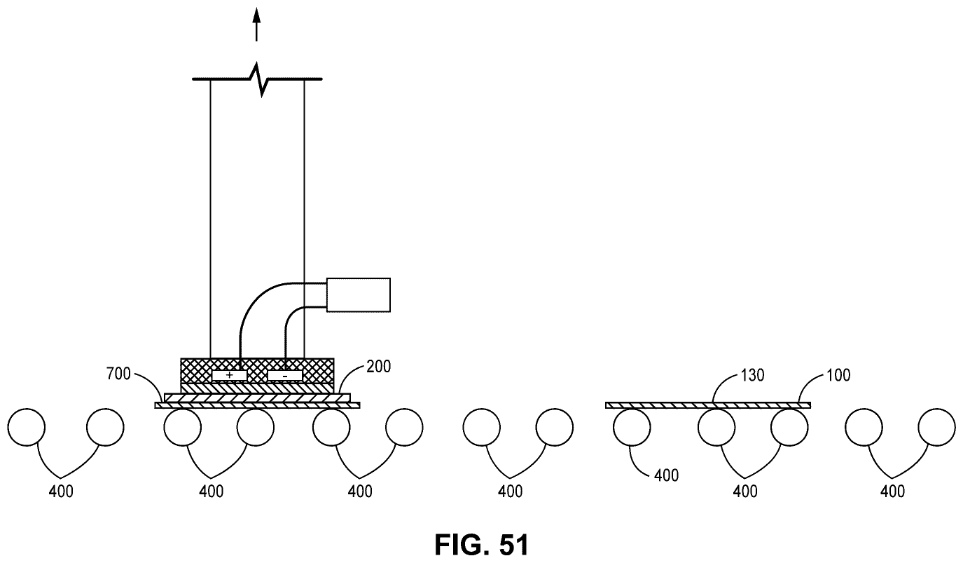

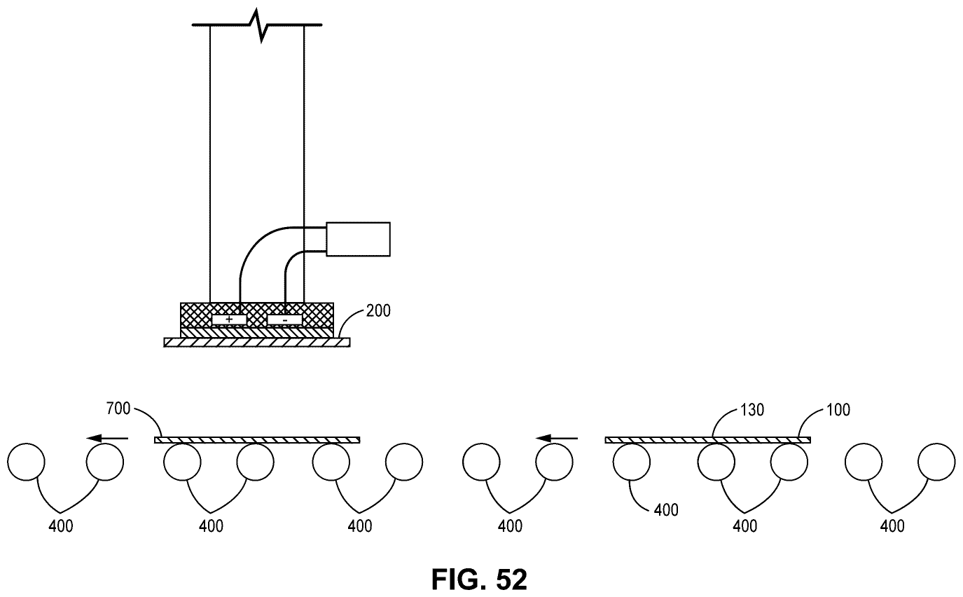

FIG. 50 shows an aerogel sheet 200 on a support substrate 700 beneath a gripper that is configured to move downwardly toward the aerogel sheet and pick it up off the support substrate. FIG. 51 shows the gripper in a lowered position, adjacent the aerogel sheet 200. At this stage, the gripper preferably has already been actuated, is actuated at that time, or is otherwise operated so as to pick the aerogel sheet 200 off the support substrate 700. FIG. 52 shows the gripper after it has picked the aerogel sheet 200 and lifted it up, thereby separating it from the support substrate 700. Once the aerogel sheet 200 has been separated from the support substrate 700, the support substrate can optionally be removed (e.g., conveyed or otherwise moved away) from a working position beneath the gripper, at which point the pane 100 can be positioned at (e.g., conveyed or otherwise moved to) the working position beneath the gripper.

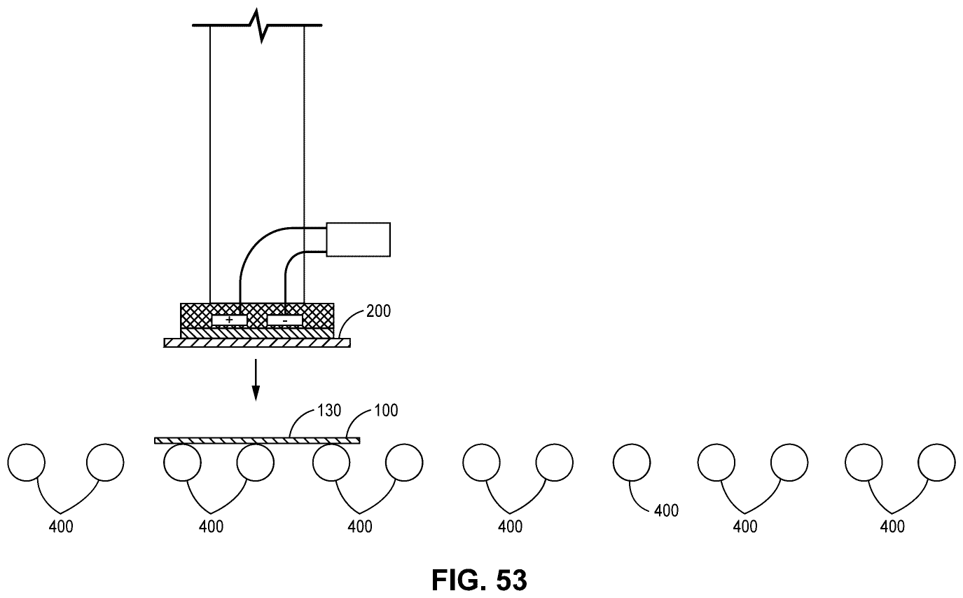

One non-limiting example of such an operation can be appreciated by referring to the arrows in FIG. 52. Thereafter, the gripper is holding the aerogel sheet 200 in an elevated position over the pane 100. Reference is made to FIG. 53. The gripper can then be lowered so as to position the aerogel sheet 200 on the surface 130 of the pane 100. If desired, the gripper can press the aerogel sheet 200 forcibly against the surface 130 of the pane 100. This may advantageously bond the aerogel sheet 200 to the surface 130 of the pane 100 (e.g., due to van der Waals bonding).

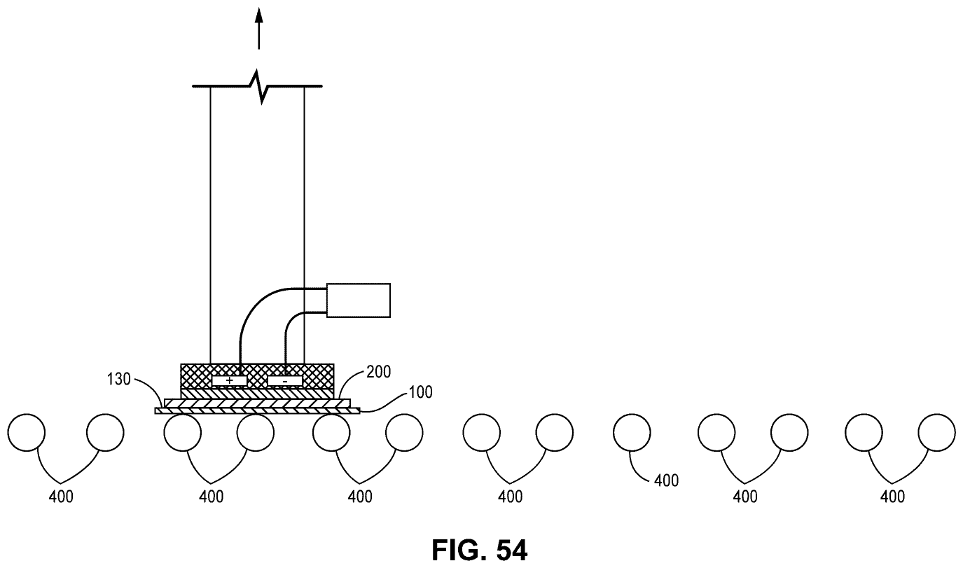

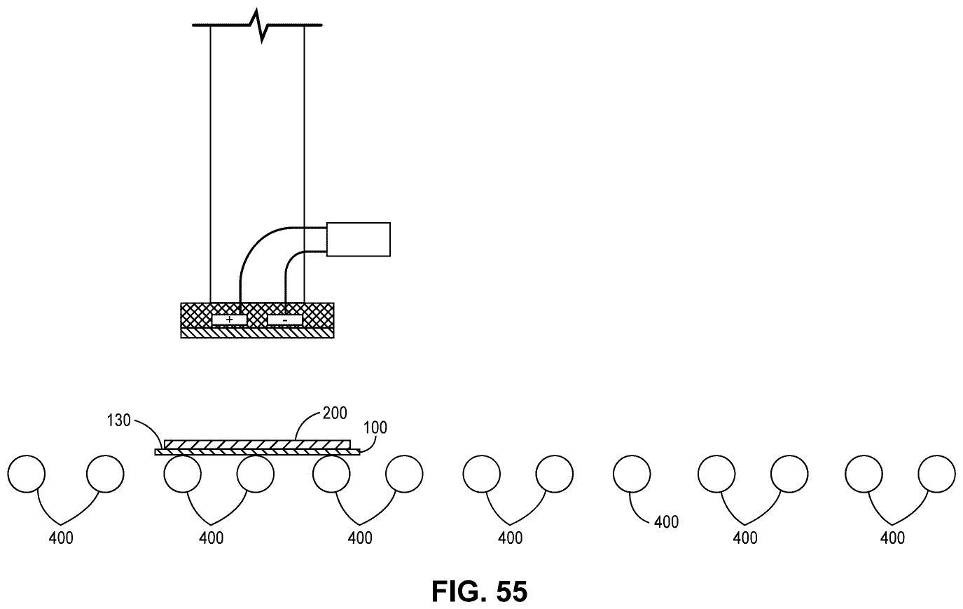

FIG. 54 shows the gripper in the process of positioning the aerogel sheet 200 on the surface 130 of the pane 100. The gripper can then be deactivated or otherwise operated so as to cease (or at least reduce) its gripping force on the aerogel sheet 200, such that when the gripper is moved back to its elevated position, the aerogel sheet remains on the surface 130 of the pane 100. This can be appreciated by referring to FIG. 55.

The gripper shown in FIGS. 50-55 can optionally be of the nature described in U.S. Patent Application Publication No. US 2024/0198650, entitled “Handling Technology for Fragile Materials Such as Aerogels,” the contents of which are incorporated herein by reference.

In embodiments of the foregoing nature, it may be preferred, before positioning the aerogel sheet 200 on the surface 130 of the pane 100, to clean that surface with a solvent, corona plasma treat it, and use compressed air on it to prevent debris from getting compressed between the aerogel sheet 200 and the pane 100.

Rather than handling the aerogel sheet 200 with an automated gripper system, the aerogel sheet can be handled (e.g., picked and placed) manually. Depending on the size of the aerogel sheet 200, one or more workers can manually pick it off a support substrate 700 and place the aerogel sheet in its intended position on the surface 130 of the pane 100.

In other cases, the aerogel sheet 200 is provided on the surface 130 of the pane 100 by molding/casting it there. In embodiments of this nature, the pane 100 initially serves as the bottom of a mold used in such molding/casting.

The aerogel sheet 200, as provided on the surface 130 of the pane 100, preferably is spaced inwardly from a perimeter edge of the pane 100. Reference is made to the non-limiting examples of FIG. 33 and FIG. 50. In some cases, the aerogel sheet 200 is spaced inwardly from the perimeter edge of the pane 100 by a set-back distance in a range of from 0.25 inch to 2.0 inches, or from 0.4 inch to 1.25 inches, such as from 0.5 inch to 1 inch. In certain non-limiting examples, the pane 100 has a rectangular configuration with four sides, and the aerogel sheet 200 is spaced inwardly, at all four sides of the pane, from the perimeter edge of the pane 100 by a set-back distance in a range of from 0.25 inch to 2.0 inches, or from 0.4 inch to 1.25 inches, such as from 0.5 inch to 1 inch. It is to be appreciated, however, that various other set-back distances can be used, depending on the size and configuration of the desired IG unit and its components.

The present discussion focuses on providing an aerogel sheet 200 on surface 130 of pane 100. This discussion, however, applies mutatis mutandis to providing the aerogel sheet on any other desired pane surface. As one example, the aerogel sheet 200 can be provided in the same manner on surface 120 of pane 110. As another example, the aerogel sheet 200 can be provided in the noted manner on surface 125 of pane 110. As still another example, the aerogel sheet 200 can be provided in this manner on the interior surface of pane 1200. Thus, the present discussion of providing the aerogel sheet 200 on surface 130 of pane 100 is to be understood as more generally describing providing the aerogel sheet on any desired surface of any desired pane. The same is true for the following description of adhering the spacer 60 to the pane 100.

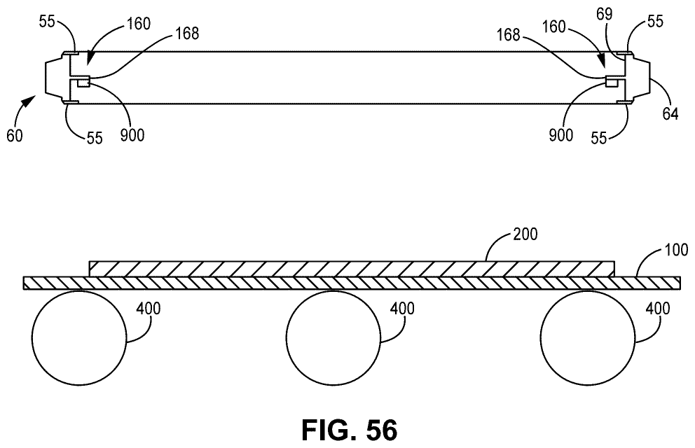

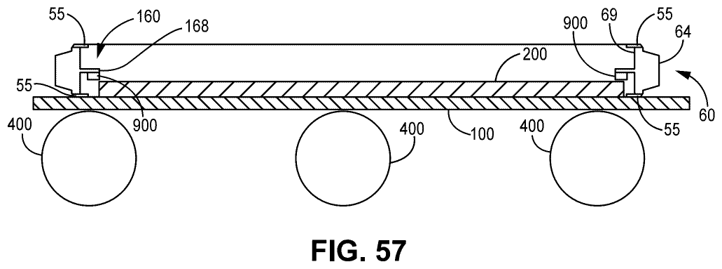

In the present method, a spacer 60 is adhered to a perimeter of the pane 100 such that the aerogel sheet 200 is sandwiched between the pane 100 and a seating structure 160 of the spacer. This can be done, for example, by moving the spacer 60 toward, and adhering it to, the pane 100. When so moving the spacer 60, it preferably already has a first bead of sealant 55 on its first side (e.g., on a first of two opposed sidewalls 63). This can be appreciated by referring to FIG. 56. In such cases, when adhering the spacer 60 onto the perimeter of the pane 100, the first bead of sealant 55 is pressed against the pane. Reference is made to FIG. 57. Moreover, the step of adhering the spacer 60 onto the perimeter of the pane 100 can optionally be done such that the perimeter edge of the aerogel sheet 200 does not contact the spacer but rather is spaced apart inwardly from the spacer.

It may be preferred that the spacer 60, when adhered to the perimeter of the pane 100, is spaced inwardly from a perimeter edge of the pane 100 by ½ inch or less. In some cases, the spacer 60, when adhered to the perimeter of the pane 100, is spaced inwardly from a perimeter edge of the pane 100 by ½ inch at each side of the pane. It is to be appreciated, however, that various other set-back dimensions may alternatively be used.

In certain preferred embodiments of the present method, when adhering the spacer 60 onto the perimeter of the pane 100, the spacer is moved toward the pane while the spacer already has first and second beads of sealant 55 located respectively on first and second opposed sides (e.g., on both of two opposed sidewalls 63) of the spacer. This is shown in FIG. 56. In such cases, when adhering the spacer 60 onto the perimeter of the pane 100, the first bead of sealant 55 is pressed against this pane. This can be done manually, for example, by one or more workers handling the spacer 60 and carefully pressing it against the pane 100, e.g., such that the first bead of sealant 55 is pressed against the pane. In other cases, this is done through automation, such as by a robot configured to remove spacers from a conveyor and attach them to respective panes. As one example, an automated robot arm equipped with a gripper frame may be used. Some examples of automated robot arms equipped with gripper frames for picking and placing IG unit spacers are disclosed in U.S. Pat. No. 11,536,083, entitled “Automated Spacer Processing Systems and Methods,” the contents of which are incorporated herein by reference.

In some embodiments, the pane 100 is maintained in a horizontal position when: (i) moving the aerogel sheet 200 toward the surface 130 of the pane 100 and positioning the aerogel sheet on the surface of the pane, and (ii) adhering the spacer 60 onto the perimeter of the pane 100. This is shown in FIGS. 56-57.

At this stage in the process, the invention provides a preliminary glazing assembly comprising a pane 100, an aerogel sheet 200 positioned on (and optionally bonded to) a surface 130 of the pane, and a spacer 60 adhered to a perimeter of the pane 100 such that the aerogel sheet 200 is sandwiched between the pane 100 and a seating structure 160 of the spacer. One non-limiting example is shown in FIG. 57. Thus, certain embodiments of the invention provide a preliminary glazing assembly of this nature.

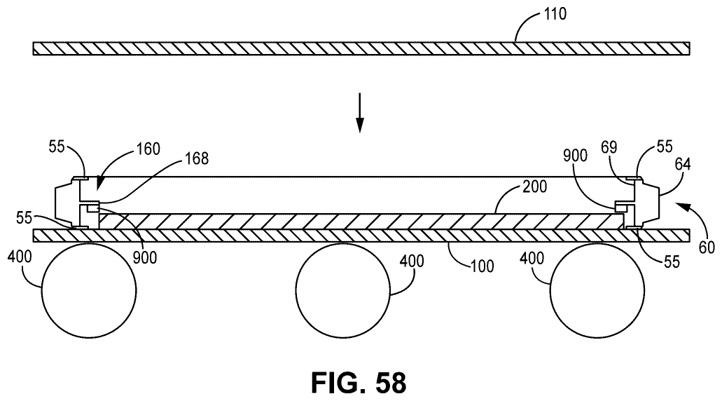

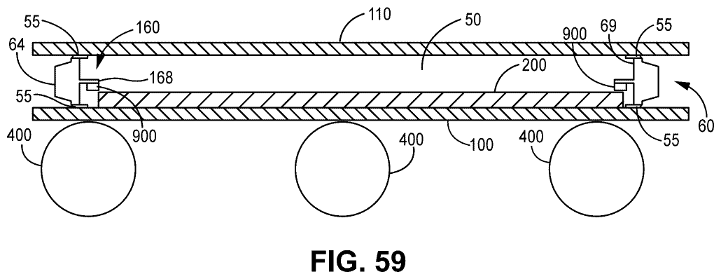

Preferably, the method further includes moving a second pane 110 toward the first pane 100 and pressing the second pane against a second bead of sealant 55 on the spacer 60. Reference is made to the non-limiting example of FIGS. 58 and 59. As illustrated, this can optionally be done such that there is a gas gap between the aerogel sheet 200 and the second pane 110. In more detail, the manufacturing method can be performed such that the gas gap has a width in a range of from 8 mm to 19 mm, and the aerogel sheet 200 has a thickness of greater than 2 mm but less than 8 mm. It is to be appreciated, however, that these details are by no means limiting.

In some preferred embodiments, the step of moving a second pane 110 onto the preliminary glazing assembly is performed such that an entirety of the spacer 60 is located between the two panes 100, 110. This can be appreciated by referring to FIG. 59.

As noted above, the aerogel sheet 200 has opposed first and second faces and a perimeter edge. In some embodiments, the method manufactures the IG unit 40 (and the preliminary glazing assembly) such that the seating structure 160 of the spacer 60 supports the second face of the aerogel sheet 200, but there is no contact between the spacer and the perimeter edge of the aerogel sheet.

The resulting IG unit 40 includes two panes 100, 110 that respectively have first and second perimeter edges. In some cases, the method manufactures the IG unit 40 such that no part of the spacer 60 overlies the first perimeter edge, and no part of the spacer overlies the second perimeter edge.

Furthermore, the method preferably manufactures the IG unit 40 such that a sealant system is located at a perimeter edge region of the IG unit. The preferred sealant system seals the spacer to both of the two noted panes 100, 110. In more detail, the sealant system preferably comprises first and second sealant beads 55 respectively sealing the two noted panes 100, 110 to the spacer 60. When provided, these two sealant beads 55 preferably do not overly the first perimeter edge or the second perimeter edge. Moreover, the sealant system can optionally further include a sealant deposit 58 over an outside wall 64 of the spacer 60. In such cases, one can optionally manufacture the IG unit 40 such that the first and second sealant beads 55 and the sealant deposit 58 are all located entirely between the two noted panes. Thus, the sealant system can optionally comprise one or more deposits of sealant 55, 58, with no part of the sealant system overlying the first perimeter edge, and no part of the sealant system overlying the second perimeter edge.

Referring to FIG. 59, a sealant deposit 58 forming a secondary sealant may be applied into the edge channel bounded collectively by the spacer 60 and the confronting interior edge regions of the two illustrated panes 100, 110. As noted above, such secondary sealant may be, for example, silicone. Furthermore, if the resulting IG unit is intended to be a triple-pane IG unit, then a second spacer and a third pane preferably are added.

As described previously, the seating structure 160 of the spacer 60 can be provided in different forms. In some cases, the seating structure 160 comprises a mounting rib 168. Various optional details and features of such a mounting rib 168 have already been described. Furthermore, the spacer 60 can optionally include an inside wall 69 having at least one base portion, which preferably faces (e.g., is exposed to) a between-pane space 50 of the resulting IG unit 40. In certain preferred embodiments, the spacer 60 has an inside wall 69 comprising two base portions located on opposite sides of a mounting rib 168. Various examples are shown and described in this disclosure. If desired, a mounting rib 168 can be located at a center point along a width of the spacer 60. In some cases, the spacer 168 includes a mounting rib 168 having an aspect ratio of greater than 5, or even greater than 8. The aspect ratio here is defined as the height of the mounting rib 168 divided by the width of the mounting rib.

In some of the present embodiments, the method manufactures the IG unit 40 such that the aerogel sheet 200 is surrounded by the spacer 60, and the thickness of the aerogel sheet is less than 50% of the width of the spacer. In embodiments of this nature, the thickness of the aerogel sheet preferably is greater than 16% of the width of the spacer. Various examples of this nature are shown in the figures. From the many examples illustrated and discussed herein, it will be appreciated that the IG unit 40 can include one or more (e.g., two, three, or four) aerogel sheets 200 of this nature.

In the present methods, the spacer 60 used in manufacturing the IG unit 40 can optionally have a hollow interior space 62, which may be empty other than containing desiccant 67. It is to be appreciated, however, that various other spacer styles can be used, including some that have no such hollow interior space. For embodiments where the spacer 60 is a metal channel spacer, it may initially be cut to the desired length, optionally filled with desiccant, bent, and then optionally stored in a desiccated location until use. With the seating structure 160 in some cases projecting inwardly further than the rest of the spacer 60, when the spacer is bent, it may have significantly rounded internal corners. In such cases, it may therefore be desirable to round or remove each external corner of an aerogel sheet 200 accordingly, so that rounded internal corners of the spacer do not interfere with external corners of the aerogel sheet. When this is done with an aerogel sheet configured for use in a rectangular IG unit, the aerogel sheet may still have a configuration that is at least generally rectangular.

In some of the present methods, the IG unit 40 is manufactured such that a gasket 900 is located between the aerogel sheet 200 and the seating structure 160 of the spacer 60. In such cases, the step of adhering the spacer 60 onto the perimeter of the pane 10 is performed such that the gasket 900 is compressed between the aerogel sheet 200 and the seating structure 160 of the spacer. Thus, in some embodiments, the method includes simultaneously performing: (i) pressing the first bead of sealant 55 against the first pane 100, and (ii) compressing a gasket 900 between the aerogel sheet 200 and the seating structure 160 of the spacer 60.

The invention provides certain method embodiments wherein the pane 100 has a rectangular configuration with four sides, and the step of adhering the spacer 60 onto the perimeter of the pane 100 is performed such that, along all four sides of the pane, the gasket 900 is compressed between the aerogel sheet 200 and the seating structure 160 of the spacer. When provided, the gasket 900 preferably is softer and/or more compressible than the aerogel sheet 200. In some examples, the gasket 900 comprises one or more pieces of foam. When foam is used, it preferably has a composition that does not outgas substantially into the IG unit 40. As shown in FIGS. 58 and 59, there preferably is no adhesive between the aerogel sheet 200 and one or more pieces of foam, which can optionally form part (or all) of the gasket 900. In the non-limiting example of FIGS. 58 and 59, the illustrated gasket 900 can optionally comprise foam that is attached to the seating structure 160 of the spacer 60 by an adhesive. This can be advantageous, for example, in embodiments where the spacer 60 is moved in a downward direction when adhering the spacer 60 onto the perimeter of the pane 100. Such adhesive can help, for example, in preventing such one or more pieces of foam from falling off the spacer 60 if/when moving it downwardly toward the pane 100. One suitable adhesive is 3M 9082 adhesive, which can be purchased commercially from 3M Company (St. Paul, Minnesota, U.S.A.) as a transparent double-sided, 2 mil (0.05 mm) adhesive transfer tape.

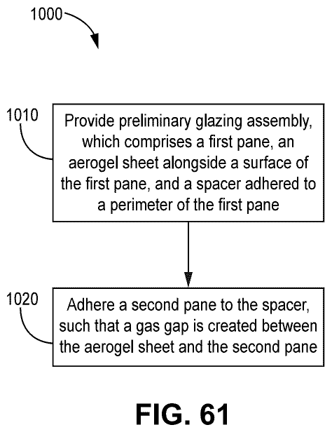

In view of the foregoing, it can be appreciated that certain methods of the invention involve a preliminary glazing assembly that comprises a first pane 100, an aerogel sheet 200 alongside (optionally bonded to) a surface 130 of the first pane, and a spacer 60 adhered to a perimeter of the first pane. Some embodiments of this nature have been described. Furthermore, the noted embodiments are exemplary of a group of embodiments wherein a method of manufacturing an IG unit 40 involves a preliminary glazing assembly of the nature described. Reference is made to the non-limiting example of FIG. 57. Furthermore, FIG. 61 depicts a method 1000 that includes a step 1010 of providing a preliminary glazing assembly of the nature described.

In the present embodiments, the method 1000 includes the step 1020 of adhering a second pane 110 to the spacer 60, such that a gas gap is created between the aerogel sheet 200 and the second pane. The first 100 and second 110 panes can optionally be in horizontal positions when adhering the second pane 110 to the spacer 60. This can be appreciated, for example, by referring to FIGS. 58 and 59. Additionally or alternatively, the step of adhering the second pane 110 to the spacer 60 can optionally include moving the second pane in a downward direction toward the first pane 100. This is perhaps best appreciated by referring to FIG. 58.

The present method can optionally result in an entirety of the spacer 60 being located between the first 100 and second 110 panes. This, however, is not required. Moreover, each of the noted first and second panes can be either of two panes of a double-pane IG unit, or they can be any two adjacent panes of a triple-pane IG unit.

In some of the present embodiments, the spacer 60 includes a seating structure 160, and the preliminary glazing assembly is characterized by the aerogel sheet 200 being sandwiched between the first pane 100 and the seating structure 160 of the spacer 60. This is not required, however, in the present group of embodiments involving the preliminary glazing assembly. Rather, in some of the present embodiments, the spacer has no such seating structure. Several exemplary spacer options of this nature are shown in FIG. 26.

In some of the present embodiments, the spacer 60 has an inside wall 69 comprising a base portion configured to face (and preferably be exposed to) a between-pane space 50 of the IG unit 40, and the spacer includes an optional seating structure 160 that projects inwardly relative to the base portion such that the seating structure is configured to project further into the between-pane space 50 of the IG unit 40 than any other part of the spacer.

In the present embodiments, when the spacer 60 includes a seating structure 160, it can optionally comprise a mounting rib 168. Various optional features and configurations of such a mounting rib 168 have already been described.

The aerogel sheet 200 has a perimeter edge. Preferably, the preliminary glazing assembly is characterized by the perimeter edge of the aerogel sheet 200 not contacting the spacer 60, but rather being spaced apart inwardly from the spacer. Although this is not required, various optional features and configurations of such arrangements are described and illustrated in this disclosure.

In addition, the first pane 100 has a peripheral edge. Preferably, the preliminary glazing assembly is characterized by the aerogel sheet 200 being spaced inwardly from the peripheral edge of the first pane 100 by a set-back distance in a range of from 0.25 inch to 2 inches, or from 0.4 inch to 1.25 inches, such as from 0.5 inch to 1 inch. It is to be appreciated, however, that various other set-back distances can be used, depending on the size and configuration of the desired IG unit and its components.

While some preferred embodiments of the invention have been described, it should be understood that various changes, adaptations and modifications may be made therein without departing from the spirit of the invention and the scope of the appended claims.

What is claimed is:

1. A multiple-pane insulating glazing unit comprising first and second panes, a spacer, and an aerogel sheet, the spacer maintaining the first and second panes in a substantially parallel spaced-apart arrangement with a between-pane space located between the first and second panes, wherein the spacer has a seating structure that facilitates retaining the aerogel sheet in a seated position within the between-pane space.

2. The multiple-pane insulating glazing unit of claim 1 wherein an entirety of the spacer is located between the first and second panes.

3. The multiple-pane insulating glazing unit of claim 1 wherein the aerogel sheet has opposed first and second faces and a perimeter edge, and the seated position is characterized by a first face of the aerogel sheet being carried alongside a desired one of the first and second panes.

4. The multiple-pane insulating glazing unit of claim 3 wherein the seated position is characterized by the first face of the aerogel sheet being in contact with the desired one of the first and second panes.

5. The multiple-pane insulating glazing unit of claim 3 wherein a gas gap is located alongside the second face of the aerogel sheet.

6. The multiple-pane insulating glazing unit of claim 5 wherein the aerogel sheet is sandwiched between the seating structure of the spacer and the desired one of the first and second panes, such that the seating structure of the spacer thereby supports the second face of the aerogel sheet, but there is no contact between the spacer and the perimeter edge of the aerogel sheet.

7. The multiple-pane insulating glazing unit of claim 1 wherein the spacer has opposed first and second sidewalls, the first and second sidewalls of the spacer being sealed respectively to the first and second panes.

8. The multiple-pane insulating glazing unit of claim 1 wherein the first and second panes respectively have first and second perimeter edges, and wherein no part of the spacer overlies the first perimeter edge, and no part of the spacer overlies the second perimeter edge.

9. The multiple-pane insulating glazing unit of claim 8 wherein part of the multiple-pane insulating glazing unit is a sealant system located at a perimeter edge region of the multiple-pane insulating glazing unit, such that the sealant system seals the spacer to both the first and second panes, the sealant system comprising one or more deposits of sealant, wherein no part of the sealant system overlies the first perimeter edge, and no part of the sealant system overlies the second perimeter edge.

10. The multiple-pane insulating glazing unit of claim 9 wherein the sealant system comprises first and second sealant beads respectively sealing the first and second panes to the spacer, and the sealant system further comprises a sealant deposit over an outside wall of the spacer, wherein the first and second sealant beads and the sealant deposit are each located entirely between the first and second panes.

11. The multiple-pane insulating glazing unit of claim 1 wherein the aerogel sheet has a perimeter edge, and the perimeter edge of the aerogel sheet does not contact the spacer but rather is spaced apart inwardly from the spacer.

12. The multiple-pane insulating glazing unit of claim 11 wherein part of the multiple-pane insulating glazing unit is a sealant system located at a perimeter edge region of the multiple-pane insulating glazing unit, such that the sealant system seals the spacer to both the first and second panes, the sealant system comprising one or more deposits of sealant, wherein the perimeter edge of the aerogel sheet does not contact the sealant system but rather is spaced apart inwardly from the sealant system.

13. The multiple-pane insulating glazing unit of claim 1 wherein the aerogel sheet is sandwiched between the seating structure of the spacer and a desired one of the first and second panes.

14. The multiple-pane insulating glazing unit of claim 13 wherein there is no adhesive between the aerogel sheet and the seating structure of the spacer.

15. The multiple-pane insulating glazing unit of claim 13 wherein the aerogel sheet has opposed first and second faces, the first face of the aerogel sheet is carried against the desired one of the first and second panes, and the second face of the aerogel sheet is carried against the seating structure of the spacer, such that the spacer supports the aerogel sheet only at the second face of the aerogel sheet.

16. The multiple-pane insulating glazing unit of claim 13 further comprising a gasket between the aerogel sheet and the seating structure of the spacer.

17. The multiple-pane insulating glazing unit of claim 16 wherein the gasket comprises one or more pieces of foam.

18. The multiple-pane insulating glazing unit of claim 17 wherein there is no adhesive between the aerogel sheet and the one or more pieces of foam.

19. The multiple-pane insulating glazing unit of claim 1 wherein the seating structure of the spacer comprises a mounting rib.

20. The multiple-pane insulating glazing unit of claim 19 wherein the spacer includes an inside wall having two base portions located on opposite sides of the mounting rib.

21. The multiple-pane insulating glazing unit of claim 19 wherein the mounting rib is located at a center point along a width of the spacer.

22. The multiple-pane insulating glazing unit of claim 19 wherein the mounting rib has an aspect ratio of greater than 5, wherein the aspect ratio is defined as a height of the mounting rib divided by a width of the mounting rib.

23. The multiple-pane insulating glazing unit of claim 22 wherein the aspect ratio of the mounting rib is greater than 8.

24. The multiple-pane insulating glazing unit of claim 20 wherein the aerogel sheet has a perimeter edge that is adjacent to, but spaced apart inwardly from, a desired one of the two base portions of the spacer's inside wall.

25. The multiple-pane insulating glazing unit of claim 1 wherein a gas gap is located along one side of the aerogel sheet, the first and second panes each have a rectangular configuration, and the aerogel sheet has a configuration that is at least generally rectangular, such that the aerogel sheet has a width and a length that are smaller than a width and a length of the first and second panes, and wherein an entirety of the spacer is located between the first and second panes.

26. The multiple-pane insulating glazing unit of claim 25 wherein the aerogel sheet is surrounded by the spacer, the aerogel sheet has a perimeter edge and opposed first and second faces, and the seating structure of the spacer supports a second face of the aerogel sheet, such that the aerogel sheet is sandwiched between the seating structure of the spacer and a desired one of the first and second panes.

27. The multiple-pane insulating glazing unit of claim 26 wherein the spacer includes an inside wall comprising a base portion that faces the between-pane space, and the seating structure of the spacer projects inwardly relative to the base portion of the inside wall to support the second face of the aerogel sheet.

28. The multiple-pane insulating glazing unit of claim 26 wherein the spacer supports the aerogel sheet only at the second face of the aerogel sheet.

29. The multiple-pane insulating glazing unit of claim 1 wherein the spacer has a width, the aerogel sheet has a thickness, the aerogel sheet is surrounded by the spacer, and the thickness of the aerogel sheet is less than 50% of the width of the spacer.

30. The multiple-pane insulating glazing unit of claim 29 wherein the thickness of the aerogel sheet is greater than 16% of the width of the spacer.

31. The multiple-pane insulating glazing unit of claim 1 wherein the spacer has a hollow interior space that is empty other than containing some particulate desiccant.

32. A multiple-pane insulating glazing unit comprising first and second panes, a spacer, and an aerogel sheet, the aerogel sheet having a perimeter edge and opposed first and second faces, wherein the spacer maintains the first and second panes in a substantially parallel spaced-apart arrangement with a between-pane space located between the first and second panes, and the spacer has a seating structure such that the aerogel sheet is sandwiched between the seating structure of the spacer and a desired one of the first and second panes, the aerogel sheet having a major dimension that is smaller than a corresponding major dimension of the desired one of the first and second panes, such that the perimeter edge of the aerogel sheet is set back inwardly from a perimeter edge of the desired one of the first and second panes.

33. The multiple-pane insulating glazing unit of claim 32 wherein an entirety of the spacer is located between the first and second panes.

34. The multiple-pane insulating glazing unit of claim 32 wherein the first face of the aerogel sheet is carried alongside the desired one of the first and second panes, wherein a gas gap is located alongside the second face of the aerogel sheet, and the seating structure of the spacer supports the second face of the aerogel sheet, but the spacer does not contact the perimeter edge of the aerogel sheet.

35. The multiple-pane insulating glazing unit of claim 34 wherein the spacer includes an inside wall comprising a base portion that faces the between-pane space, and the seating structure of the spacer projects inwardly relative to the base portion of the inside wall to support the second face of the aerogel sheet.

36. The multiple-pane insulating glazing unit of claim 32 wherein the first and second panes respectively have first and second perimeter edges, wherein no part of the spacer overlies the first perimeter edge, and no part of the spacer overlies the second perimeter edge.

37. The multiple-pane insulating glazing unit of claim 36 wherein part of the multiple-pane insulating glazing unit is a sealant system located at a perimeter edge region of the multiple-pane insulating glazing unit, such that the sealant system seals the spacer to both the first and second panes, the sealant system comprising one or more deposits of sealant, wherein no part of the sealant system overlies the first perimeter edge, and no part of the sealant system overlies the second perimeter edge.
